(19) United States
(12) Patent Application Publication
(10) Pub. No.: US 2008/0079680 A1
(43) Pub. Date: Apr. 3, 2008

(54) Driving circuit and driving method of liquid crystal device, liquid crystal device, and electronic apparatus

(75) Inventor: Shin Fujita, Suwa-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-Shi (JP)

(21) Appl. No.: 11/902,033

(22) Filed: Sep. 18, 2007

(30) Foreign Application Priority Data
Sep. 28, 2006 (JP) 2006-264486
Aug. 1, 2007 (JP) 2007-200434

(51) Int. Cl. G09G 3/36

(52) U.S. Cl. 345/89

(57) ABSTRACT

Any one can be selected out of an entire screen display mode and a partial screen display mode, a driving circuit including; a scanning line driving circuit; a first control circuit for supplying the plurality of common electrodes with any one of a first voltage, a second voltage higher than the first voltage, and a predetermined voltage; a data line driving circuit for supplying a positive image signal when a common electrode is switched to the first voltage and for supplying a negative image signal when the common electrode is switched to the second voltage in the entire screen display mode and in the partial screen display mode; and a second control circuit for supplying the data lines with the voltage when the selection voltage is applied to one of the scanning lines associated with the non-display area in the partial screen display mode.

### BACKGROUND

1. Technical Field

The present invention relates to a technology designed to improve display quality in a liquid crystal device including pixel electrodes and common electrodes in one substrate.

2. Related Art

A liquid crystal device that displays an image using liquid crystal is known. Such a liquid crystal device, for example, includes a liquid crystal panel and a backlight arranged to be opposite the liquid crystal panel. The liquid crystal panel includes a pair of substrates and liquid crystal interposed between the pair of substrates. In addition, the liquid crystal panel includes pixels corresponding to a plurality of scanning lines and a plurality of data lines arranged so as to intersect with each other. Moreover, capacitance lines are provided so as to correspond to the plurality of scanning lines.

Pixels are provided at the intersections of the scanning lines and the data lines. Each pixel includes a pixel capacitor having a pixel electrode and a common electrode, a thin-film transistor (hereinafter, referred to as a TFT), and a storage capacitor of which one electrode is connected to the capacitance line and the other electrode is connected to the pixel electrode. The pixels are arranged in matrices to form a display area. A gate of the TFT is connected to a corresponding scanning line, a TFT source is connected to a corresponding data line, and a TFT drain is connected to a corresponding pixel electrode and another corresponding electrode of the storage capacitor.

In the above-described liquid crystal panel, a scanning line driving circuit connected to the plurality of scanning lines, a data line driving circuit connected to the plurality of data lines, and a capacitance line driving circuit connected to the plurality of capacitance lines are provided. The scanning line driving circuit sequentially supplies a selection voltage for selecting a scanning line to the plurality of scanning lines. For example, when supplying the selection voltage to any scanning line, the TFT connected to the corresponding scanning line is turned on and the pixel related to the corresponding scanning line is selected. The data line driving circuit supplies an image signal to the plurality of data lines when the scanning lines are selected. An image voltage based on the image signal is applied to the pixel electrodes through TFTs in the ON state.

The data line driving circuit supplies the data lines with the image signal the voltage (in the related art, referred to as a positive polarity) of which is higher than that of the common electrode and applies the image voltage based on the image signal having the positive polarity to the pixel electrodes. The data line driving circuit supplies the data lines with the image signal the voltage (in the related art, referred to as a negative polarity) of which is lower than that of the common electrode and applies the image voltage based on the image signal having the negative polarity to the pixel electrodes. At this time, the data line driving circuit alternately performs application of a positive polarity voltage and application of a negative polarity voltage for every one horizontal scanning period.

The capacitance line driving circuit supplies a predetermined voltage to the capacitance lines.

The above-described liquid crystal device operates as follows.

The selection voltage is sequentially supplied to the scanning lines to turn TFTs connected to the scanning lines to the ON state and all of the pixels related to the scanning lines are selected. In addition, in synchronization with the selection of the pixels, the image signal is supplied to the data lines. Accordingly, the image signal is supplied to all the selected pixels through TFTs in the ON state and the image voltage based on the image signal is applied to the pixel electrodes.

When the image voltage is applied to the pixel electrodes, a potential difference between the pixel electrodes and the common electrodes induces a driving voltage to be applied to the liquid crystal. When the driving voltage is applied to the liquid crystal, alignment or order of molecules of the liquid crystal is changed, light transmitted through the liquid crystal from a backlight is changed, and a gray scale level is displayed. The driving voltage is applied to the liquid crystal for an interval three orders of magnitude greater than the interval of time for which the image voltage is applied by the storage capacitors.

The above-described liquid crystal device is used for, for example, a portable apparatus. However, there has recently been a demand for reducing the power consumption of portable apparatuses. Accordingly, there has been a need for a liquid crystal device capable of having reduced power consumption by applying the image voltage to the pixel electrodes, and subsequently turning TFTs to an OFF state and changing the voltage of the capacitance lines (for example, see JP-A-2002-196358).

An operation of the liquid crystal device of the known example that changes the voltage of the capacitance lines in the manner described in the known technology will be described with reference to FIGS. 32 and 33. In the case of the voltage being applied to the liquid crystal device related to the known example, FIG. 32 is a diagram illustrating a voltage waveform of each unit in the application of a positive polarity and FIG. 33 is a diagram illustrating a voltage waveform of each unit in the application of a negative polarity.

In this case, the liquid crystal device related to the known example, for example, has 320 scanning lines and 320 capacitance lines arranged in rows and 240 data lines arranged in columns. In FIGS. 32 and 33, GATE(v) denotes a voltage of the scanning line of a v-th row (where v is an integer satisfying 1≦v≦320) and VST(v) denotes a voltage of the scanning line of the v-th row. SOURCE(w) denotes a voltage of the data line of a w-th column (where w is an integer satisfying 1≦w≦240). PIX(v, w) denotes a voltage of the pixel electrode of a pixel in the v-th row and the w-th column corresponding to an intersection of the v-th scanning line and the w-th data line. VCOM denotes a voltage of a common electrode commonly provided for each pixel.

First, in the application of the positive polarity shown in FIG. 32, when the scanning line driving circuit supplies the selection voltage to the v-th scanning line at time t101, the voltage GATE(v) of the v-th scanning line increases, and thus becomes a voltage VGH at time t102. In this way, TFTs connected to the v-th scanning line all turn on.

When the data line driving circuit supplies the positive image signal to the w-th data line at time t33, the voltage SOURCE(w) of the w-th data line increases, and thus becomes a voltage VP8 at time t103.

The voltage SOURCE(w) of the w-th data line that is the image voltage based on the positive image signal is applied to the pixel electrode of the pixel in the v-th row and the w-th column through the ON state TFT connected to the v-th scanning line. For this reason, a voltage PIX(v, w) of the pixel electrode of the pixel in the v-th row and the w-th column increases, and thus becomes the voltage VP8 at time t104, which is the same as the voltage SOURCE (w) of the w-th data line.

When the scanning line driving circuit stops supplying the selection voltage to the v-th scanning line at time t105 and supplies a non-selection voltage instead, the voltage GATE(v) of the v-th scanning line decreases, and thus becomes the voltage VGL at time t106. In this way, TFTs connected to the v-th scanning line all enter the OFF state.

When the capacitance line driving circuit supplies a predetermined voltage to the v-th capacitance line at time t106, a voltage VST(v) of the v-th capacitance line increases, and thus becomes a voltage VSTH at time t107. When the voltage VST(v) of the v-th capacitance line increases, charges corresponding to the increased voltage are distributed to the storage capacitors and the pixel capacitors in all pixels related to the v-th capacitance line. For this reason, the voltage PIX(v, w) of the pixel electrode of the pixel in the v-th row and the w-th column increases again, and thus becomes a voltage VP9 at time t1.

That is, in the liquid crystal device related to the known example, when the positive polarity is applied, the image voltage based on the image signal having the positive polarity is applied to the pixel electrodes, and then the voltage of the capacitance lines is increased. Accordingly, the voltage of the pixel electrodes increases by as much as a sum of a voltage increase caused by the charges corresponding to the voltage increase of the image voltage and the increase of the voltage of the capacitance lines.

Next, an operation of application of the negative polarity will be described with reference to FIG. 33.

When the scanning line driving circuit supplies the selection voltage to the v-th scanning line at time till, the voltage GATE(v) of the v-th scanning line increases, and thus becomes the voltage VGH at time t112. In this way, TFTs connected to the v-th scanning line all turn on.

When the data line driving circuit supplies the image signal having the negative polarity to the w-th data line at time t113, the voltage SOURCE(w) of the w-th data line decreases, and thus becomes a voltage VP11 at time t114.

The voltage SOURCE(w) of the w-th data line that is the image voltage based on the image signal having the negative polarity is applied to the image electrode of the pixel in the-v row and the w-th column through the ON state TFT connected to the v-th scanning line. For this reason, the voltage PIX(v, w) of the pixel electrode of the pixel in the v-th row and the w-th column decreases, and thus becomes a voltage VP11 at time t114, which is the same as the voltage SOURCE(w) of the w-th data line.

When the scanning line driving circuit stops supplying the selection voltage to the v-th scanning line at time t115 and supplies the non-selection voltage, the voltage GATE(v) of the v-th scanning line decreases, and thus becomes a voltage VGL at time t116. In this way, TFTs connected to the v-th scanning line all turn off.

When the capacitance line driving circuit supplies a predetermined voltage to the v-th capacitance line at time t116, the voltage VST(v) of the v-th capacitance line decreases, and thus becomes a voltage VSTL at time 117.

When the voltage VST(v) of the v-th capacitance line decreases, charges corresponding to the decreased voltage are distributed to the storage capacitors and the pixel capacitors in all pixels related to the v-th capacitance line. For this reason, the voltage PIX(v, w) of the pixel electrode of the pixel in the v-th row and the w-th column decreases again, and thus becomes a voltage VP10 at time t117.

In this way, in the liquid crystal device of the known example, when the negative polarity is applied, the image voltage based on the image signal having the negative polarity is applied to the pixel electrodes, and then the voltage of the capacitance lines is increased. Accordingly, the voltage of the pixel electrodes increases by as much as a sum of a voltage decreased by the charges corresponding to the voltage decreased by the image voltage and the decreased voltage of the capacitance lines.

In the liquid crystal device as described in the known example, even when an amplitude of the image voltage is reduced, a potential difference between the voltage of the common electrodes and the voltage of the pixel electrodes can be increased by applying the image voltage to the image electrodes and changing the voltage of the capacitance lines. As a result, a display quality can be prevented from deteriorating by maintaining the amplitude of the driving voltage applied to the liquid crystal and the consumption power can be reduced by reducing the amplitude of the image voltage.

In the above-described liquid crystal device related to the known example, the voltage of the capacitance lines is changed and the charges are moved between the storage capacitors and the pixel capacitors to change the voltage of the pixel electrodes. For this reason, when deterioration in characteristics occurs among the storage capacitors, an amount of charge moving between the storage capacitors and the pixel capacitors is affected. Accordingly, even when the same image voltage is applied to the pixel electrodes, the brightness of each pixel is not uniform due to the different voltage of each pixel. As a result, the display quality may deteriorate.

Further, in the above-described liquid crystal device related to the known example, since the voltage of the capacitance lines is changed to be different from that of the pixel electrodes or the common electrodes, one electrode of the storage capacitors connected to the capacitance lines is required to be separately formed from the pixel electrodes or the common electrodes. For this reason, in liquid crystal devices using modes such as In-Plane Switching (IPS) and Fringe-Field Switching (FFS) in which the pixel electrodes and the common electrodes constituting the pixel capacitors are provided on one substrate of a pair of substrates with liquid crystal interposed therebetween and the pixel capacitors and the storage capacitors are incorporated, it is difficult to form the liquid crystal device as described in the above-described known example.

### SUMMARY

An advantage of some aspects of the invention is that it provides a driving circuit, a liquid crystal device, an electronic apparatus, and a method of driving the liquid crystal device capable of preventing a display quality from deteriorating and reducing a consumption power in the liquid crystal device including pixel electrodes and common electrodes constituting pixel capacitors on one substrate of a pair of substrates interposing liquid crystals.

According to an aspect of the invention, there is provided a driving circuit of a liquid crystal device having a first substrate, a second substrate disposed opposite the first substrate, and liquid crystal interposed between the first substrate and the second substrate, wherein the first substrate has a plurality of scanning lines, a plurality of data lines, a plurality of common electrodes provided every predetermined number of scanning lines, and pixels that are provided at intersections between the scanning lines and the data lines, that each have a pixel switching element of which one end is connected to the corresponding data line and which is conductive with an application of a selection voltage to the scanning line, and a pixel capacitor of which one end is connected to the corresponding common electrode and the other end is connected to the other end of the pixel switching element, and that exhibit gray scales corresponding to holding voltages of the pixel capacitors and wherein any one can be selected out of an entire screen display mode in which an effective display is performed using all the pixels and a partial screen display mode in which effective display is performed using only the pixels corresponding to the scanning lines associated with a display area and the pixels corresponding to the scanning lines associated with a non-display area are not used, the driving circuit including; a scanning line driving circuit for supplying the selection voltage to the plurality of scanning lines in a predetermined order in the entire screen display mode and in the partial screen display mode; a first control circuit for supplying the plurality of common electrodes with any one of a first voltage, a second voltage higher than the first voltage, and a predetermined voltage, for switching a voltage applied to a common electrode corresponding to one scanning line from any one of the first voltage and the second voltage to the other before the selection voltage is applied to the one scanning line in the entire screen display mode and before the selection voltage is applied to one scanning line associated with the display area in the partial screen display mode, and for holding the voltage applied to common electrode corresponding to the scanning line associated with the non-display area in the partial screen display mode at any one of the first voltage, the second voltage, and the predetermined voltage; a data line driving circuit for supplying a positive image signal having a voltage corresponding to the gray scales of pixels corresponding to the scanning lines to which the selection voltage is applied and being higher than the first voltage when a common electrode corresponding to the scanning line to which the selection voltage is applied is switched to the first voltage and for supplying a negative image signal having the voltage corresponding to the gray scales of pixels and being lower than the second voltage when the common electrode corresponding to the scanning line to which the selection voltage is applied is switched to the second voltage in a case where the selection voltage is applied to one of the plurality of scanning lines in the entire screen display mode and in a case where the selection voltage is applied to any one of the scanning lines associated with the display area in the partial screen display mode; and a second control circuit for supplying the data lines with the voltage applied to common electrodes corresponding to the scanning lines to which the selection voltage is applied when the selection voltage is applied to one of the scanning lines associated with the non-display area in the partial screen display mode.

According to the driving circuit with the above-described configuration, in the display area in the entire screen display mode and the display area in the partial screen display mode, the application of the positive polarity is carried out after the first voltage is supplied to the common electrode and the application of the negative polarity is carried out after the second voltage is supplied to the common electrode. Accordingly, it is difficult for charges to move after the application in the pixel capacitor. For this reason, even when irregularity in characteristic of the storage capacitor occurs, it is difficult for deterioration to occur in the voltage of the pixel electrode. Accordingly, since the display in each pixel is performed, it is possible to prevent a display quality from deteriorating. Moreover, according to the driving circuit, an individual capacitance line is not required. As a result, it is not required to change the voltage of the capacitance line to a voltage different from the voltage of the pixel electrode or the common electrode. Since the pixel electrode and the common electrode are formed on the first substrate, it is possible to easily apply them to the liquid crystal device using a mode of IPS or FFS. Moreover, according to the driving circuit, since a voltage which is the same as the voltage applied to the pixel electrode is applied to the common electrode in the non-display area in the partial screen display mode, the voltage held in the pixel electrode becomes zero. As a result, a consumption power can be reduced in the pixels of the non-display area.

In the driving circuit having the above-described configuration, the data line driving circuit may alternately switch between the positive image signal and the negative image signal whenever the predetermined number of scanning lines is selected. In this way, when the positive image signal and the negative image signal are alternately switched, flicker of the mutual pixels in which the negative polarity is applied can be compensated. As a result, it is possible to further prevent the display quality from deteriorating. In particular, the common electrode may be provided in correspondence with the corresponding scanning line.

In the driving circuit having the above-described configuration, the first control circuit may have a latch circuit and a selection circuit, the latch circuit may have unit latch circuits provided for the plurality of common electrodes, each unit latch circuit may latch a polarity signal for instructing use of a positive polarity and negative image signal to the data line driving circuit when the selection voltage is applied to one of two lines adjacent to the scanning line corresponding to the corresponding common electrode, the selection circuit may have unit selection circuits provided for the plurality of common electrodes, all the unit selection circuits in the entire screen display mode and the unit selection circuit corresponding to the common electrodes corresponding to the scanning lines associated with the display area in the partial screen display mode may apply one of the first voltage and the second voltage to the corresponding common electrodes on the basis of the polarity signal latched by the latch circuit, and the unit selection circuits corresponding to the common electrodes corresponding to the scanning line associated with the non-display area in the partial screen display mode may apply one of the first voltage, the second voltage, and the predetermined voltage to the corresponding common electrode. According to the above-described configuration, the first control circuit switches the voltage of the common electrode when the selection voltage is applied to one of the adjacent scanning lines. Accordingly, a direction in which the selection voltage is applied to the scanning lines is not limited.

In the driving circuit having the above-described configuration, the first control circuit may have a latch circuit and a selection circuit, the latch circuit may have unit latch circuits provided for the plurality of common electrodes, each unit latch circuit may latch a polarity signal for instructing use of a positive polarity and negative image signal to the data line driving circuit when the selection voltage is applied to the more previous scanning line by one line than the scanning line corresponding to the corresponding common electrode, the selection circuit may have unit selection circuits provided for the plurality of common electrodes, all the unit selection circuits in the entire screen display mode and the unit selection circuits corresponding to the common electrodes corresponding to the scanning line associated with the display area in the partial screen display mode may apply one of the first voltage and the second voltage to the corresponding common electrode on the basis of the polarity signal latched by the latch circuit, and the unit selection circuits corresponding to the common electrodes corresponding to the scanning line associated with the non-display area in the partial screen display mode may apply one of the first voltage, the second voltage, and the predetermined voltage to the corresponding common electrode. According to the above-described configuration, the first control circuit focuses only the more previous scanning line by one line than the scanning line to which the selection voltage is applied. As a result, it is possible to simplify the configuration more than the configuration for detecting whether the selection voltage is applied to one of the two adjacent scanning lines.

In the driving circuit having the above-described configuration, the first control circuit may have a latch circuit and a selection circuit, the latch circuit may have unit latch circuits provided for the plurality of common electrodes, each unit latch circuit may latch a polarity signal for instructing use of a positive polarity and negative image signal to the data line driving circuit when the selection voltage is applied to the more previous scanning line by one line than the scanning line corresponding to the common electrode, the selection circuit may have a first unit selection circuit provided corresponding to the common electrode corresponding to the scanning line associated with a predetermined display area and a second unit selection circuit provided on the basis of the common electrode corresponding to the scanning line associated with a predetermined non-display area, the first unit selection circuit may apply one of the first voltage and the second voltage to the corresponding common electrode on the basis of the polarity signal latched by the latch circuit, and the second unit selection circuit may apply one of the first voltage and the second voltage to the corresponding common electrode on the basis of the polarity signal latched by the latch circuit in the entire screen display mode and applies one of the first voltage, the second voltage, and the predetermined voltage to the corresponding common electrode in the partial screen display mode. According to the above-described configuration, the first unit selection circuit applies one of the first voltage and the second voltage on the basis of the polarity signal latched by the latch circuit regardless of the entire screen display mode and the partial screen display mode. As a result, it is possible to simplify the configuration as the second unit selection circuit.

According to another aspect of the invention, there is provided a method of driving a liquid crystal device in addition to the driving circuit of the liquid crystal device. In addition, according to still another aspect of the invention, there is provided a liquid crystal device. In the liquid crystal device, the plurality of common electrodes may correspond to the plurality of scanning lines line by line and may be opposed to a line of the pixel electrodes along an extending direction of the scanning lines line by line, and supplementary common lines of the common electrodes may be disposed along the extending direction of the scanning lines and the common electrodes and a set of a common electrode and the supplementary common line may be connected to each other through contact wirings provided at a predetermined interval. According to such a configuration, since the common electrode is connected in parallel to the supplementary common line, a time constant is reduced. As a result, it is possible to prevent the display quality from deteriorating due to waveform reduction or the like. In addition, according to still another aspect of the invention, there is an electronic apparatus having the liquid crystal device.

### BRIEF DESCRIPTION OF THE DRAWINGS

The invention will be described with reference to the accompanying drawings, wherein like numbers reference like elements.

FIG. 1 is a block diagram illustrating a liquid crystal device according to a first embodiment of the invention.

FIG. 2 is a diagram illustrating a display screen in a partial screen display mode of the liquid crystal device according to the first embodiment of the invention.

FIG. 3 is an enlarged top view illustrating pixels included by the liquid crystal device according to the first embodiment of the invention.

FIG. 4 is a sectional view illustrating the pixels included by the liquid crystal device according to the first embodiment of the invention.

FIG. 5 is a block diagram illustrating a scanning line driving circuit in the liquid crystal device according to the first embodiment of the invention.

FIG. 6 is a block diagram illustrating a control circuit in the liquid crystal device according to the first embodiment of the invention.

FIG. 7 is a block diagram illustrating a latch circuit in the control circuit according to the first embodiment of the invention.

FIG. 8 is a block diagram illustrating a configuration of the display mode circuit in the control circuit according to the first embodiment of the invention.

FIG. 9 is a block diagram illustrating a voltage selection circuit in the control circuit according to the first embodiment of the invention.

FIG. 10 is a diagram illustrating voltages of the scanning lines and the common lines in an entire screen display mode.

FIG. 11 is a diagram illustrating a voltage waveform of each unit in the application of the positive polarity in the entire screen display mode.

FIG. 12 is a diagram illustrating the voltage waveform of each unit in the application of the negative polarity in the entire screen display mode.

FIG. 13 is a diagram illustrating the voltage waveforms of the scanning lines and the common lines in the partial screen display mode.

FIG. 14 is a diagram illustrating the voltage waveforms in the application of the positive polarity in the display area in the partial screen display mode.

FIG. 15 is a diagram illustrating the voltage waveforms in the application of the negative polarity in the display area in the partial screen display mode.

FIG. 16 is a diagram illustrating the voltage waveforms in the application to 26th row in the partial screen display mode.

FIG. 17 is a diagram illustrating the voltage waveforms in the application to 26th row in the partial screen display mode.

FIG. 18 is a diagram illustrating the voltage waveforms in the application in the non-display area in the partial screen display mode.

FIG. 19 is a block diagram illustrating another configuration of a latch circuit according to the first embodiment.

FIG. 20 is a block diagram illustrating other configuration of the latch circuit according to the first embodiment.

FIG. 21 is a block diagram illustrating the control circuit in the liquid crystal device according to a second embodiment of the invention.

FIG. 22 is a block diagram illustrating the display mode circuit in the control circuit according to the second embodiment.

FIG. 23 is a block diagram illustrating the voltage selection circuit in the control circuit according to the second embodiment of the invention.

FIG. 24 is a diagram illustrating voltages of the scanning lines and the common lines in an entire screen display mode.

FIG. 25 is a diagram illustrating the voltage waveforms in the application of the positive polarity in the display area in the partial screen display mode.

FIG. 26 is a diagram illustrating the voltage waveforms in the application of the positive polarity in the display area in the partial screen display mode.

FIG. 27 is a diagram illustrating the voltage waveforms in the application to 26th row in the partial screen display mode.

FIG. 28 is a diagram illustrating the voltage waveforms in the application to 26th row in the partial screen display mode.

FIG. 29 is a diagram illustrating the voltage waveforms in the application in the non-display area in the partial screen display mode.

FIG. 30 is an enlarged top view illustrating pixels according to a third embodiment of the invention.

FIG. 31 is a perspective view illustrating a configuration of a cellular phone to which the above-described liquid crystal device is applied.

FIG. 32 is a timing chart for illustrating an application of the positive polarity in the liquid crystal related to a known example.

FIG. 33 is a timing chart for illustrating an application of the positive polarity in the liquid crystal related to a known example.

### DESCRIPTION OF EXEMPLARY EMBODIMENTS

Hereinafter, embodiments of the invention will be described with reference to the drawings. In the description of the following embodiments and modified example, the same reference numerals and symbols are given to the same constituents and repeated description thereof will be omitted or simplified.

### First Embodiment

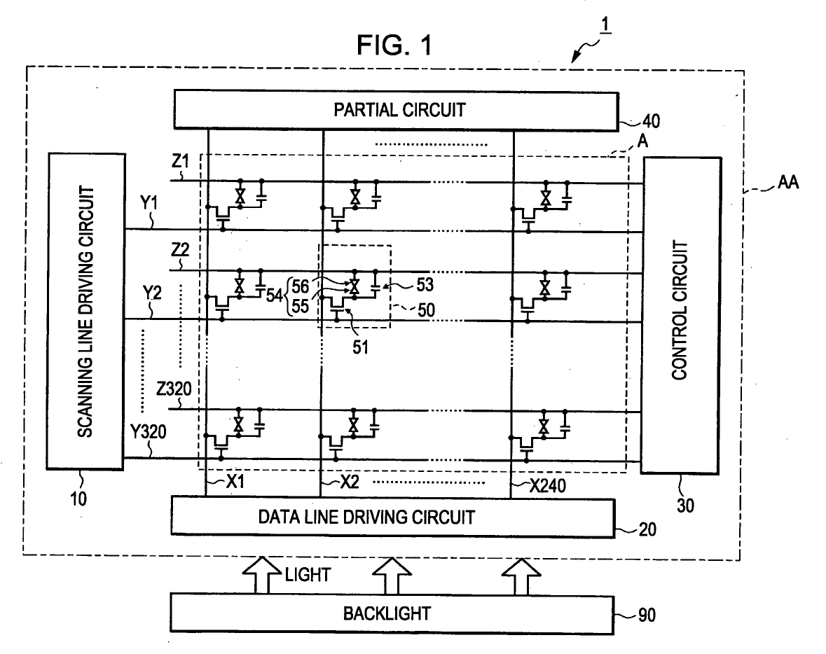

First, a liquid crystal device according to a first embodiment of the invention will be described. FIG. 1 is a block diagram illustrating a liquid crystal device 1 according to the first embodiment.

As shown in FIG. 1, the liquid crystal device 1 includes a liquid crystal panel AA and a backlight 90 which is disposed opposite the liquid crystal panel AA and emits light. The liquid crystal device 1 performs transmissive display using light emitted from the backlight 90.

The liquid crystal panel AA includes a display screen A, a scanning line driving circuit 10, a data line driving circuit 20, a control circuit 30, and a partial circuit 40. In the display screen A, a plurality of pixels 50 are arranged in matrices to display an image. The scanning line driving circuit 10 and the data line driving circuit 20 are arranged in a periphery of the display screen A and are driving circuits for driving the display panel AA. The control circuit 30 is a first control circuit and the partial circuit 40 is a second control circuit.

The liquid crystal panel AA has a function of selecting an entire screen display mode in which the entire area of the display screen A is a display area and a partial screen display mode in which a partial area of the display screen A is a display area and the other area is a non-display area.

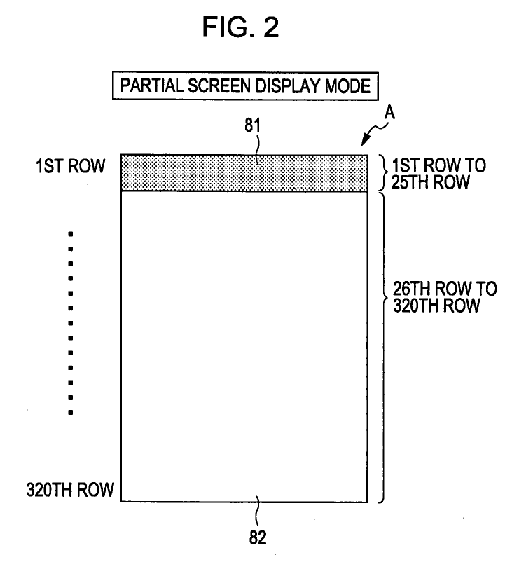

FIG. 2 is a diagram illustrating the display screen A in a partial screen display mode of the liquid crystal device.

In the partial screen display mode, the display screen A is divided into a display area 81 and a non-display area 82 according to an extending direction (row) of the scanning line. In the display area 81, an image that is a battery remaining quantity display or a view angle display is displayed. In the non-display area 82, an off-display image is displayed. Moreover, since the liquid crystal device according to the first embodiment operates in a normally black mode, a black image is displayed as the off-display image in the non-display area 82, and thus the display is not used.

In the first embodiment, the display area 81 and the non-display area 82 are not fixed, but are variable. However, for convenience of description, the display area 81 is constituted by the pixels 50 in the 1st row to 25th row and the non-display area 82 is constituted by the pixels 50 in the 26th row to 320th row.

As shown in FIG. 1, the backlight 90 emits light from the rear surface of the liquid crystal panel AA. The backlight 90 is formed of a cold cathode fluorescent lamp (CCFL), a light-emitting diode (LED), or an electro luminescence (EL) element.

Next, a configuration of the liquid crystal panel AA will be described in detail.

In the liquid crystal panel AA, 320 scanning lines Y1 to Y320 and 320 common lines Z1 to Z320 alternately arranged at every predetermined interval are provided. In addition, 240 data lines X1 to X240 which intersect the scanning lines Y1 to Y320 and the common lines Z1 and Z320 and are arranged at every predetermined interval are provided. At this time, each scanning line and each common line are paired in one row.

Moreover, when the lines are particularly not assigned among the scanning lines Y1 to Y320, but are generally assigned, the scanning line is referred to as Y. Similarly, when the lines are particularly not assigned among the common lines Z1 to Z320, but are generally assigned, the common line is referred to as Z. In addition, when the lines are particularly not assigned among the data lines X1 to X240, but are generally assigned, the data line is referred to as X.

The pixels 50 are arranged at intersections of the scanning lines Y1 to Y320 and the data lines X1 to X320. Each pixel 50 includes a TFT 51, a pixel capacitor 54 having a pixel electrode 55 and a common electrode 56, and a storage capacitor 53 of which one electrode is connected to the common line Z and the other electrode is connected to the pixel electrode 55. The common electrodes 56 are electrically partitioned every horizontal line and each common electrode 56 is a common line.

A gate of each TFT 51 is connected to a corresponding scanning line Y and a source of each TFT 51 is connected to a corresponding data line X. A drain of each TFT 51 is connected to the corresponding pixel electrode 55 and other electrode of the corresponding storage capacitor 53. With a selection voltage applied to the scanning lines Y, TFTs 51 that are turned on and the data lines X allow the pixel electrodes 55 and the other electrodes of the storage capacitors 53 to enter a conductive state.

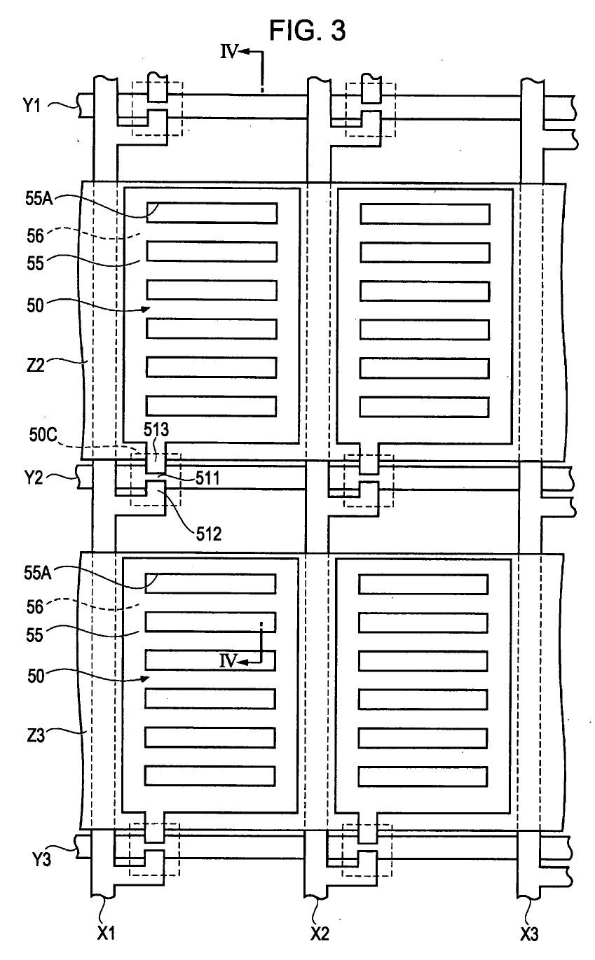

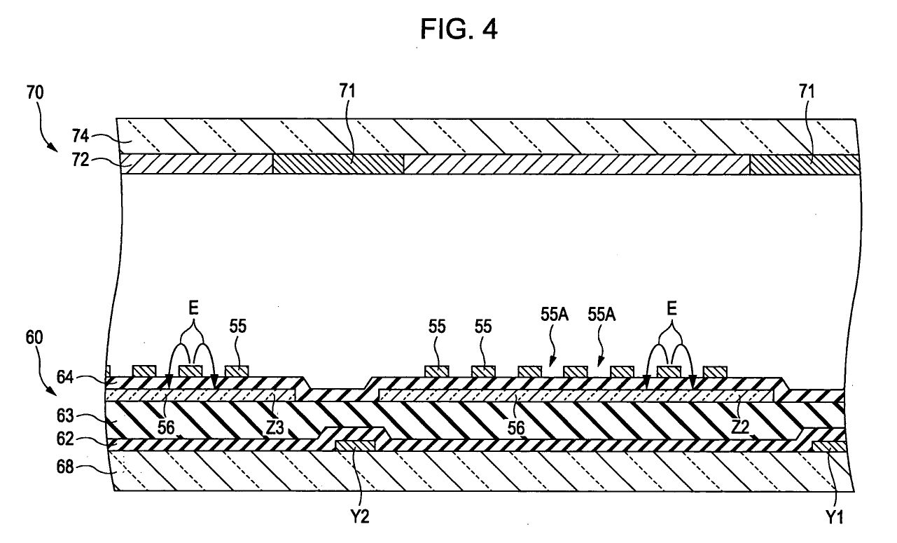

FIG. 3 is an enlarged top view illustrating the pixels 50. FIG. 4 is a sectional view illustrating the pixels 50 taken along the line A-A shown in FIG. 3. In addition, FIG. 3 shows four pixels corresponding to intersections of the second scanning line Y2 and the third scanning line Y3 and the first data line X1 and the second data line X2.

The liquid crystal panel AA includes an element substrate 60 that is a first substrate, a counter substrate 70 that is a second substrate and is disposed opposite the element substrate 60, and liquid crystal that is interposed between the element substrate 60 and the counter substrate 70.

The scanning lines Y1 to Y320, the common lines Z1 to Z320, and the data lines X1 to X240 are arranged in the element substrate 60. Each pixel 50 is formed in an area surrounded by two mutually adjacent scanning lines Y and two mutually adjacent data lines X. That is, the pixels 50 are partitioned by the scanning lines Y and the data lines X.

In this embodiment, each TFT 51 is an inverse staggered amorphous silicon TFT and an area 50C (area surrounded by a dashed line shown in FIG. 2) in which a TFT 51 is formed is provided in the vicinity of each intersection of the scanning lines Y and the data lines X.

The element substrate 60 will be described.

The element substrate 60 includes a glass substrate 68. On the glass substrate 68, a ground insulating film (not shown) is formed across the entire surface of the element substrate 60 in order to prevent TFTs 51 from deteriorating due to roughness or staining of the surface of the glass substrate 68.

The scanning lines Y made of a conductive material are formed on the ground insulating film.

The scanning lines Y are arranged along the boundary of the adjacent pixels 50 and gate electrodes 511 of TFTs 51 are formed in the vicinity of the intersections of the scanning lines Y and the data lines X.

On the scanning lines Y (the gate electrodes 511) and the ground insulating film, a gate insulating film 62 is formed across the entire surface of the element substrate 60.

In the areas 50C in which TFTs 51 on the gate insulating film 62 are formed, a semiconductor layer (not shown) made of amorphous silicon and an ohmic contact layer (not shown) made of N+amorphous silicon are laminated to be opposite the gate electrodes 511. Source electrodes 512 and drain electrodes 513 are laminated on the ohmic contact layer, and the amorphous silicon TFTs are formed in this way.

The source electrodes 512 are formed of the same conductive material as the data lines X. That is, the source electrodes 512 extend from the data lines X. Since both are incorporated with each other, it is not necessary to electrically distinguish both from each other. The data lines X and the scanning lines Y intersect each other.

As described above, the gate insulating film 62 is formed on the scanning lines Y and the data lines X are formed on the gate insulating film 62. Accordingly, the data lines X are insulated from the scanning lines Y by the gate insulating film 62.

On the data lines X (the source electrodes 512), the drain electrodes 513, and the gate insulating film 62, a first insulating film 63 is formed across the entire surface of the element substrate 60.

The common lines Z made of a transparent conductive material such as indium tin oxide (ITO) and indium zinc oxide (IZO) are formed on the first insulating film 63. The common lines Z are formed along the scanning lines Y. In addition, since the common lines Z that extend from the common electrodes 56 are incorporated with each other, it is not required to electrically distinguish both from each other.

On the common lines Z (the common electrodes 56) and the first insulating film 63, a second insulating film 64 is formed across the entire surface of the element substrate 60.

On the second insulating film 64, the pixel electrodes 55 made of the transparent conductive material such as ITO or IZO are formed on the areas opposite the common electrodes 56. The pixel electrodes 55 are electrically connected to the drain electrodes 513 through contact holes (not shown) formed in the first insulating film 63 and the second insulating film 64 described above.

A plurality of slits 55A are provided at every predetermined interval in the pixel electrodes 55 in order to generate a fringe field (an electric field E) between the pixel electrodes 55 and the corresponding common electrode 56. That is, the liquid crystal device 1 is an FFS-type liquid crystal device.

On the pixel electrodes 55 and the second insulating film 64, an alignment film (not shown) formed of an organic film such as a polyimide film is formed across the entire surface of the element substrate 60.

Subsequently, the counter substrate 70 will be described in detail.

The counter substrate 70 includes a glass substrate 74. As block matrices, light-shielding films 71 are formed in areas on the glass substrate 74 that are not opposite the pixel electrodes 55. Color filters 72 are formed on the areas on the glass substrate 74 other than the areas in which the light-shielding films 71 are formed, that is the area opposite the pixel electrodes 55.

On the light-shielding films 71 and the color filters 72, the alignment film (not shown) is formed across the entire surface of the counter substrate 70.

In FIG. 1, the control circuit 30 individually supplies any one of a voltage VCOML, which is the first voltage, a voltage VCOMH, which is the second voltage and is higher than the voltage VCOML, and a voltage VCOML, which is a predetermined voltage, to the common lines Z1 to Z320.

The scanning line driving circuit 10 sequentially supplies the selection voltage to the scanning lines Y1 to Y320. In this case, when the selection voltage is supplied to some of the scanning lines Y, TFTs 51 connected to some of the scanning lines Y all turn on and the pixels 50 related to some of the scanning lines Y are all selected.

The data line driving circuit 20 supplies an image signal to the data lines X1 to X240 and applies an image voltage based on the image signal to the pixel electrodes 55 through the TFTs 51 in the ON state. The data line driving circuit 20 supplies the data lines X with a positive image signal of which the voltage is higher than the voltage VCOML and applies the image voltage based on the positive image signal to the pixel electrodes 55. The data line driving circuit 20 supplies the data lines X with a negative image signal of which the voltage is lower than the voltage VCOMH and applies the image voltage based on the negative image signal to the pixel electrodes 55. At this time, the data line driving circuit 20 alternately performs application of the positive polarity and application of the negative polarity for every one horizontal scanning period.

When the selection voltage is applied to the scanning line associated with a non-display area 82, a partial circuit 40 supplies the voltage VCOML, which is a predetermined voltage, to the data lines X1 to X240.

The liquid crystal device 1 generally operates in the entire screen display mode as follows.

First, the control circuit 30 supplies the voltage VCOML or VCOMH to the common line Z(a) of an a-th row (where a is an integer satisfying 1≦a≦320).

Specifically, the control circuit 30 alternately supplies the voltages VCOML and VCOMH to the common line Z(a) at every one frame period. For example, when the control circuit 30 supplies the voltage VCOML to the common line Z(a) at one frame period, the control circuit 30 Z(a) at every one frame period. For example, when the control circuit 30 supplies the voltage VCOML to the common line Z(a) at one frame period, the control circuit 30 supplies the voltage VCOMH to the common line Z(a) at the next one frame period. Alternatively, when the control circuit 30 supplies the voltage VCOMH to the common line Z(a) at one frame period, the control circuit 30 supplies the voltage VCOML to the common line Z(a) at the next one frame period.

The control circuit 30 supplies mutually different voltages to the mutually adjacent common lines Z. For example, when the control circuit 30 supplies the voltage VCOML to the common line Z(a) at one frame period, the control circuit 30 supplies the voltage VCOMH to the common line Z(a−1) of the (a−1)th row and common line Z(a+1) of the (a+1)th row at the same frame period. Alternatively, when the control circuit 30 supplies the voltage VCOMH to the common line Z(a) at one frame period, the control circuit 30 supplies the voltage VCOML to the common line Z(a−1) of the (a−1)th row and common line Z(a+1) of the (a+1)th row at the same frame period.

The scanning line driving circuit 10 supplies the selection voltage to the scanning line Y(a) to turn all TFTs 51 connected to the scanning line Y(a) to the ON state and to select all pixels 50 related to the scanning line Y(a). with the positive image signal and the negative image signal at every horizontally scanning period depending on the voltage of the common line Z(a). Specifically, when the voltage of the common line Z(a) is the voltage VCOML, the positive image signal is supplied to the data lines X1 to X240. Alternatively, when the voltage of the common line Z(a) is the voltage VCOMH, the negative image signal is supplied to the data lines X1 to X240.

When the selection voltage of the scanning line Y(a) is common, the data line driving circuit 20 supplies the image signal to the pixels 50 in the a-th row and the 1 to 240th column through the data lines X1 to X240 and TFTs 51 in the ON state and the image voltage based on the image signal is applied to the pixel electrodes 55. For this reason, a potential difference between the pixel electrodes 55 and the common electrodes 56 occurs, and thus a driving voltage is applied to the liquid crystal.

With the driving voltage applied to the liquid crystal, alignment or order of the liquid crystal is changed, and thus light transmitted through the liquid crystal from a backlight 90 changes. The changed light transmits the color filters 72, thereby displaying an image.

Alternatively, the liquid crystal device 1 generally operates in the partial display mode as follows.

That is, first, when the common line Z(a) is any one of the common lines Z1 to Z25 associated with the display area 81, the control circuit 30 supplies the voltage VCOML or the voltage VCOMH to the common line Z(a). Alternatively, when the common line Z(a) is any one of the common lines Z26 to Z320 associated with the non-display area 82, the control circuit 30 supplies the voltage VCOML to the common line Z(a) as a predetermined voltage.

The scanning line driving circuit 10 makes all TFTs 51 connected to the scanning line Y(a) turn on and selects all the pixels 50 related to the scanning line Y(a) by supplying the selection voltage to the scanning line Y(a).

In this case, when the selected pixels 50 is the pixels associated with the display area 81, as described above, the data line driving circuit 20 alternately supplies the data lines X1 to X240 with the positive image signal and the negative image signal at every horizontally scanning period depending on the voltage of the common line Z(a) in synchronization with the selection of the pixels 50 related to the scanning line Y(a).

Then, the data line driving circuit 20 supplies the image signal to the pixels 50 associated with the selected display area 81 through the data lines X1 to X240 and the TFTs 51 in the ON state and the image voltage based on the image signal is applied to the pixel electrodes 55. In this way, a potential difference between the pixel electrodes 55 and the common electrodes 56 occurs, and thus a driving voltage is applied to the liquid crystal.

With the driving voltage applied to the liquid crystal, alignment or order of the liquid crystal is changed, and thus light transmitted through the liquid crystal from the backlight 90 changes. The changed light transmits the color filters 72, thereby displaying an image.

Alternatively, when the selected pixels 50 is the pixels associated with the non-display area 82, in synchronization with the selection of the pixels 50, the partial circuit 40 supplies the voltage VCOML, which is a predetermined voltage, to the data lines X1 to X240.

Then, the partial circuit 40 supplies the voltage VCOML to the pixels 50 in the selected non-display area 82 through the data lines X1 to X240 and the TFTs 51 in the ON state, and then the voltage VCOML is applied to the pixel electrodes 55.

Since the voltage VCOML is supplied to the common line Z(a) associated with the non-display area 82, the voltage of the common electrodes 56 related to the common line Z(a) is the voltage VCOML. For this reason, since the potential different between the pixel electrode 55 and the common electrode 56 does not occur, the driving voltage is not applied to the liquid crystal.

With no driving voltage applied to the liquid crystal, alignment or order of the liquid crystal is not changed. Accordingly, in the normally black mode, an OFF black image is displayed in the non-display area 82.

Moreover, the driving voltage is applied to the liquid crystal for an interval three orders of magnitude greater than the interval of time for which the image voltage is applied by the storage capacitors.

The liquid crystal device 1 operates in the entire screen display mode and the partial screen display mode in this way. Subsequently, each unit for performing operation will be described in detail one by one.

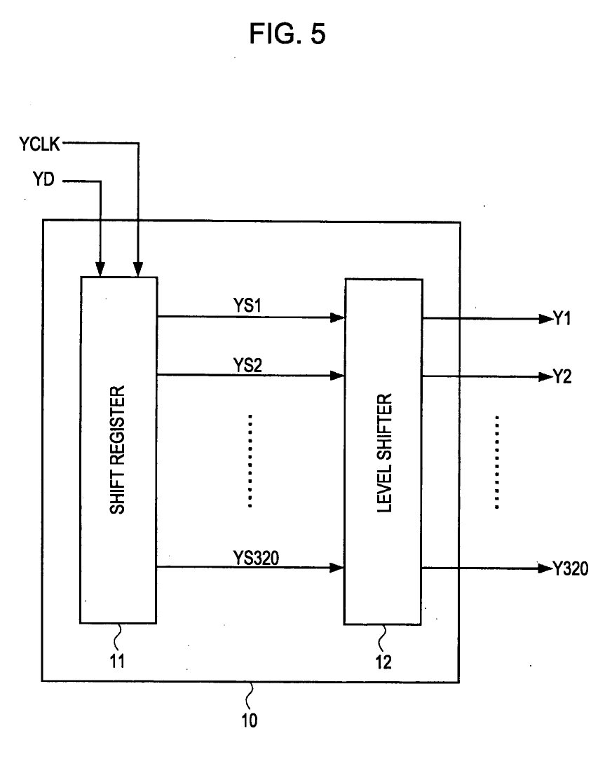

First, the scanning line driving circuit 10 will be described. FIG. 5 is a block diagram illustrating a configuration of a scanning line driving circuit 10.

As shown in FIG. 5, the scanning line driving circuit 10 includes a shift register 11 and a level shifter 12. The shift register 11, which is particularly not shown, has a configuration in which transmission circuits of 320 stages of which the number is the same as that of the scanning lines Y are subordinately connected in this embodiment.

The transmission circuits of the stages corresponding to some rows relay the input signal as much as the one period of a clock signal YCLK to output the delayed input signal as the shift signal of the stages corresponding to the rows and as the input signal of the transmission circuits of the stages corresponding to the next row, that is, the later row by one row. However, the input signal of the transmission signal of a first stage is a single start pulse YD which becomes the H level during the one period of the clock signal YCLK and is initially supplied during the one frame period.

When the shift signals of the transmission circuits of the 1st stage to the 320th stage denote YS1 to YS320, the shift signals YS1, YS2, YS3, . . . , YS320 sequentially delay the start pulse YD every the one period of the clock signal YCLK, and thus exclusively become the H level in this order.

A level shifter 12 inverts the shift signals YS1 to YS320 which are low-amplitude logic signals to supply them to the scanning lines Y1 to Y320.

Moreover, in this embodiment, the H level of a high-amplitude logic signal is the selection voltage and corresponds to the voltage VGH and the L level of the high-amplitude logic signal is the non-selection voltage and corresponds to the voltage VGL. Accordingly, the period when each of the shift signals YS1 to YS320 becomes the H level is a period when the selection voltage is applied to the scanning lines Y1 to Y320. In addition, the period corresponds to the one period of the clock signal YCLK.

The scanning line driving circuit 10 with such a configuration operates as follows.

With one frame period started, a pulse signal of the H level during one horizontally scanning period is sequentially shifted as much as one horizontally scanning period and is output as the transmission signals YS1 to YS320 by the shift register 11. The transmission signals YS1 to YS320 of which the logic level is level-shifted to a predetermined voltage are supplied to the scanning lines Y1 to Y320 by the level shifter 12.

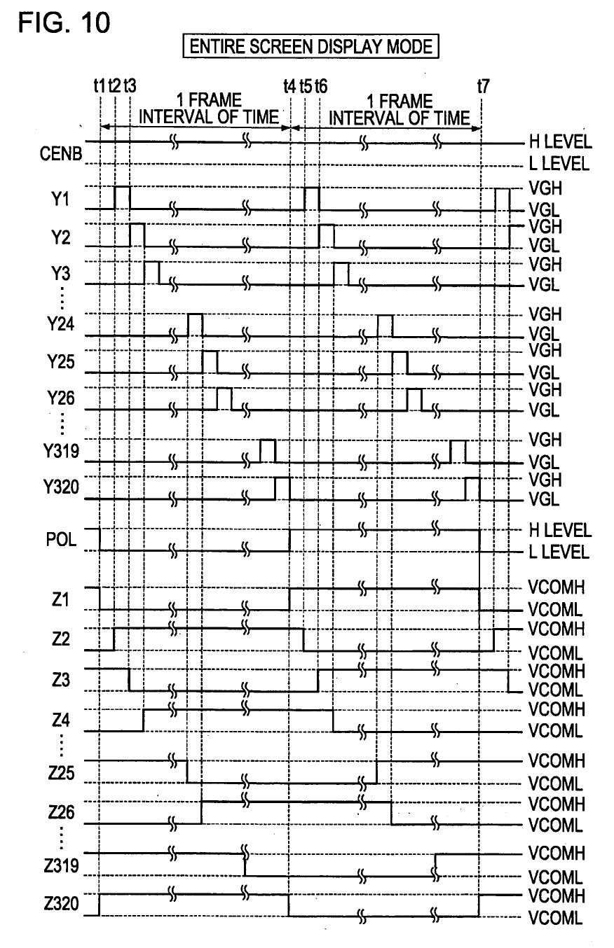

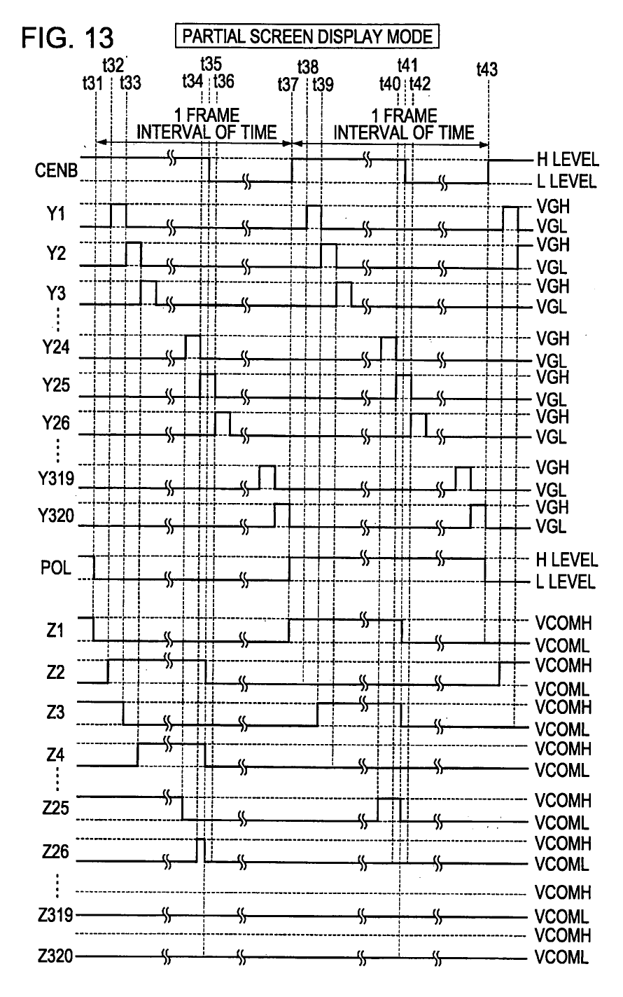

In this way, the scanning line driving circuit 10 sequentially shifts the pulse of the H level as much as one horizontally scanning period from the start of one frame period during one horizontally scanning period and supplies the pulse to the scanning lines Y1 to Y320. Moreover, the scanning line driving circuit 10 allows the scanning lines Y1 to Y320 to become the L level, which is the non-selection voltage, during a period other than the period of supplying the H level, which is the selection voltage (see FIGS. 10 and 13).

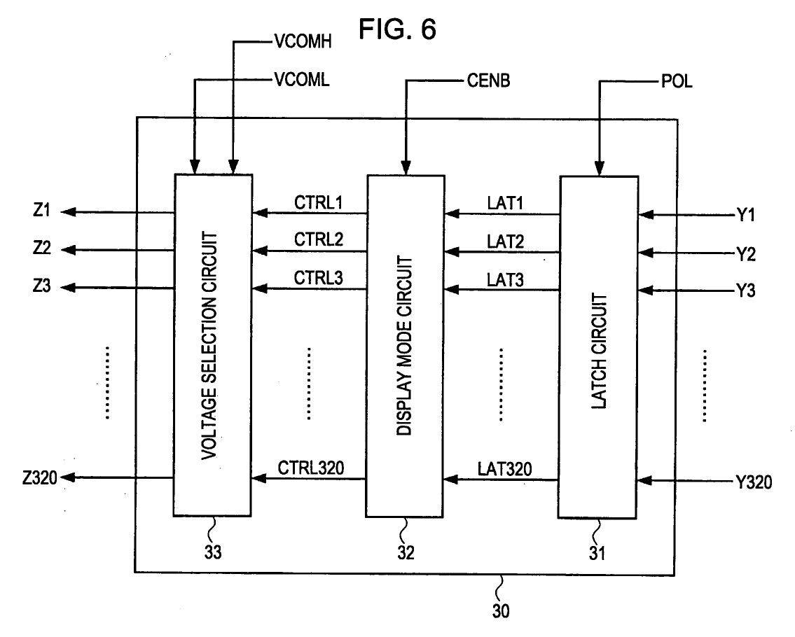

Next, the control circuit 30 will be described. FIG. 6 is a block diagram illustrating an overall configuration of the control circuit 30.

As shown in FIG. 6, the control circuit 30 includes a latch circuit 31, a display mode circuit 32, and a voltage selection circuit 33. Moreover, the display mode circuit 32 and the voltage selection circuit 33 serve as the selection circuit.

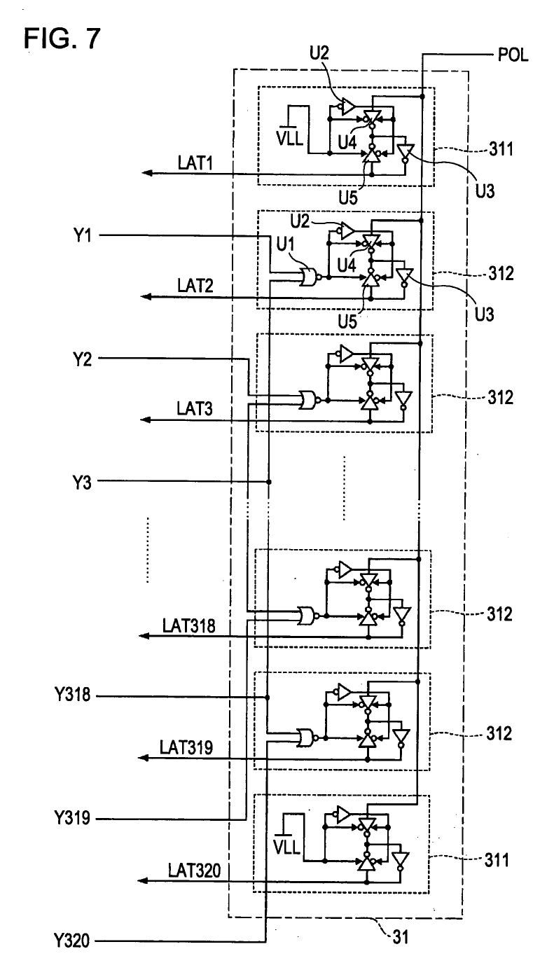

First, the latch circuit 31 will be described. FIG. 7 is a block diagram illustrating the latch circuit 31. As shown in FIG. 7, the latch circuit 31 includes a first unit latch circuit 311 corresponding to the scanning lines Y1 of a 1st row and Y320 of the last row and a second unit latch circuit 312 corresponding to the scanning lines Y2 to Y319 of the other rows.

At this time, the second unit latch circuits 312 will be described with reference to the second unit latch circuit 312(b) corresponding to the scanning line Y(b) of a b-th row (where b is an integer satisfying 2≦b≦319). The second unit latch circuit 312(b) includes an NOT-OR circuit U1 (hereinafter, referred to as an NOR circuit), a first inverter U2, a second inverter U3, a first clocked inverter U4, and a second clocked inverter U5.

In the second unit latch circuit 312 corresponding to the scanning line Y(b) of the b-th row, one input terminal and the other input terminal of two input terminals of each NOR circuit U1 are connected to the scanning line Y(b−1) of a (b−1) row and the scanning line Y(b+1) of a (b+1) row, respectively. An output terminal of the NOR circuit U1 is connected to an input terminal of the first inverter U2, an inverting input control terminal of the first clocked inverter U4, and a non-inverting input control terminal of the second clocked inverter U5.

The input terminal of each first inverter U2 is connected to the output terminal of the NOR circuit U1. An output terminal of the first inverter U2 is connected to the non-inverting input control terminal of the first clocked inverter U4 and the inverting input control terminal of the second clocked inverter U5.

A polarity signal POL is input to an input terminal of the first clocked inverter U4 and an output terminal of the first clocked inverter U4 is connected to an input terminal of the second inverter U3. The inverting input control terminal of the first clocked inverter U4 is connected to the output terminal of the NOR circuit U1 and the non-inverting input control terminal of the first clocked inverter U4 is connected to the output terminal of the first inverter U2.

The input terminal of the second inverter U3 is connected to the output terminal of the first clocked inverter U4 and an output terminal of the second clocked inverter U5. An output terminal of the second inverter U3 outputs a latch signal LAT(b) in the second unit latch circuit 312 of the b-th row and is connected to an input terminal of the second clocked inverter U5.

The input terminal of the second clocked inverter U5 is connected to the output terminal of the second inverter U3 and the output terminal of the second clocked inverter U5 is connected to the input terminal of the second inverter U3. An inverting input control terminal of the second clocked inverter U5 is connected to the output terminal of the first inverter U2 and the non-inverting input control terminal of the second clocked inverter U5 is connected to the output terminal of the NOR circuit U1.

The second unit latch circuit 312(b) of the b-th row configured in this way operates as follows.

When as the selection voltage, an H level signal is supplied to at least any one of the scanning lines Y(b−1) and Y(b+1), the NOR circuit U1 outputs an L level signal. The L level signal output from the NOR circuit U1 is input to the inverting input control terminal of the first clocked inverter U4, and a polarity of the L level signal is simultaneously inverted by the first inverter U2 so that the L level signal becomes the H level signal and is input to the non-inverting input control terminal of the first clocked inverter U4. In this way, the first clocked inverter U4 turns on so that a NOT operation is permitted, and inverts the polarity of the polarity signal POL to output the polarity signal POL. The polarity signal POL that is output with the polarity inverted by the first clocked inverter U4 is re-inverted by the second inverter U3, and then the polarity of the polarity signal POL returns. Accordingly, the logic level of the latch signal LAT(b) is the same as that of the polarity signal POL.

Alternatively, when as the non-selection voltage, the L level signal is supplied to both the scanning lines Y(b−1) and Y(b+1), the NOR circuit U1 outputs the H level signal.

The H level signal output by the NOR circuit U1 is input to the inverting input control terminal of the first clocked inverter U4, and simultaneously a polarity of the H level signal is inverted into the L level signal by the first inverter U2 and is input to the non-inverting input control terminal of the first clocked inverter U4. In this way, the first clocked inverter U4 turns off so that the NOT operation is prohibited. In addition, the H level signal output by the NOR circuit U1 is input to the non-inverting input control terminal of the second clocked inverter U5, and simultaneously a polarity of the H level signal is inverted into the L level signal by the first inverter U2 and is input to the inverting input control terminal of the second clocked inverter U5. In this way, the second clocked inverter U5 turns on so that the NOT operation is permitted.

Accordingly, the latch signal LAT(b) is latched by the second inverter U3 and the second clocked inverter U5.

In this way, when the selection voltage is supplied to at least any one of the scanning lines Y(b−1) and Y(b+1), each second unit latch circuit 312(b) receives the polarity signal POL and outputs the latch signal LAT(b) of which the logic level is the same as that of the polarity signal POL. Alternatively, when the non-selection voltage is supplied to both the scanning lines Y(b−1) and Y(b+1), the second inverter U3 and the second clocked inverter U5 maintain and output the latch signal LAT(b).

Next, the first unit latch circuit 311 will be described.

Each first unit latch circuit 311 includes a low-potential power VLL for outputting the L level signal instead of the NOR circuit U1, compared with each second unit latch circuit 312. The other configuration of each first unit latch circuit 311 is the same as that of each second unit latch circuit 312. Moreover, the voltage VLL is substantially identical with the voltage VGL of the non-selection voltage. Such voltages VLL and VGL are set to be a zero potential of a voltage reference.

The first unit latch circuit 311 with such a configuration operates in the same manner that the NOR circuit U1 in the second unit latch circuit 312 becomes the L level. That is, the first unit latch circuit 311 normally receives the polarity signal POL and outputs the LAT1 to LAT320 which are the latch signals of which the logic level is the same as that of the polarity signal POL.

In this embodiment, in the first unit latch circuits 311 provided so as to correspond to the scanning lines Y1 to Y320, the input terminal of the first inverter U2, the inverting input control terminal of the first clocked inverter U4, the non-inverting input control terminal of the second clocked inverter U5 are configured as the voltage VLL of the L level. However, the configuration is not limited thereto. For example, in the first unit latch circuit 311 provided so as to correspond to the scanning line Y1, the scanning line Y1 may be connected to the input terminal of the first inverter U2, the inverting input control terminal of the first clocked inverter U4, and the non-inverting input control terminal of the second clocked inverter U5. In addition, in the first unit latch circuit 311 provided so as to correspond to the scanning line Y320, the scanning line Y320 may be connected to the input terminal of the first inverter U2, the inverting input control terminal of the first clocked inverter U4, the non-inverting input control terminal of the second clocked inverter U5.

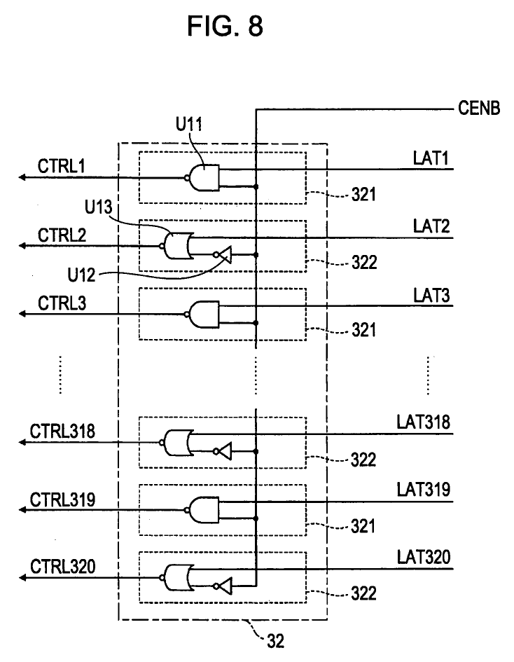

Subsequently, the display mode circuit 32 shown in FIG. 6 will be described. FIG. 8 is a block diagram illustrating a configuration of the display mode circuit 32.

As shown in FIG. 8, the display mode circuit 32 includes first unit voltage selection circuits 321 corresponding to the scanning lines Y of odd numbered rows and second unit voltage selection circuits 322 corresponding to the scanning lines Y of even numbered rows.

The first unit voltage selection circuits 321 will be described with reference to the first unit voltage selection circuit 321(c) corresponding to the scanning line Y(c) of a c-th row (where c is an odd number satisfying 1≦c≦320).

The first unit voltage selection circuit 321(c) corresponding to the odd numbered c-th row includes a NOT-AND circuit (hereinafter, referred to as an NAND circuit) U11. The latch signal LAT(c) output from the latch circuit 31 of the odd numbered c-th row and a display mode selection signal CENB are input to one input terminal and the other input terminal of the NAND circuit U11, respectively, so that NOT-AND signals of the both terminals are output as a voltage instruction signal CTRL(c).

For this reason, the display mode selection signal CENB of the H level is input in the first unit display mode circuit 321(c) of the odd numbered c-th row. At this time, when the latch signal LAT(c) output from the latch circuit 31 of the odd numbered c-th row is the H level, a voltage instruction signal CTRL(c) of the L level is output and when the latch signal LAT(c) is the L level, the voltage instruction signal CTRL(c) of the H level is output. Alternatively, when the display mode selection signal CENB of the L level is input, the voltage instruction signal CTRL(c) of the H level is output.

That is, when the display mode selection signal CENB is the H level, the first unit display mode circuit 321(c) of the odd numbered c-th row outputs the voltage instruction signal CTRL(c) in which the logic level of the latch signal LAT(c) is inverted. Alternatively, when the display mode selection signal CENB is the L level, the first unit display mode circuit 321(c) outputs the voltage instruction signal CTRL(c) of the H level on the basis of no latch signal LAT(c).

Next, the second unit voltage selection circuits 322 will be described with reference to the second unit voltage selection circuit 322(d) corresponding to the scanning line Y(d) of a d-th row (where d is an even number satisfying 2≦d≦320).

The second unit voltage selection circuit 322(d) corresponding to the even numbered d-th row includes an NOT-AND circuit U12 and an NOR circuit U13. The display mode selection signal CENB is input to an input terminal of the inverter U12 and an output terminal of the inverter U12 is connected to the other input terminal of two input terminals of the NOR circuit U13.

The latch signal LAT(d) output from the latch circuit 31 of the even numbered d-th row and the display mode selection signal CENB are input to one input terminal and the other input terminal of the NOR circuit U13, respectively, so that NOT-OR signals of the both terminals are output as a voltage instruction signal CTRL(d).

For this reason, when the display mode selection signal CENB of the H level is input in the second unit display mode circuit 322(d) of the even numbered d-th row, the signal of the L level is input to the other input terminal of the NOR circuit U13 through the inverter U12. Accordingly, when the latch signal LAT(d) is the H level, a voltage instruction signal CTRL(d) of the L level is output and when the latch signal LAT(d) is the L level, the voltage instruction signal CTRL(d) of the H level is output. Alternatively, when the display mode selection signal CENB of the L level is input, the signal of the H level is input through the inverter U12. Accordingly, the voltage instruction signal CTRL(d) of the L level is output on the basis of no logic level of the latch signal LAT(d).

That is, when the display mode selection signal CENB is the H level, the second unit display mode circuit 322(d) of the even numbered d-th row outputs the voltage instruction signal CTRL(c) in which the logic level of the latch signal LAT(c) is inverted. Alternatively, when the display mode selection signal CENB is the L level, the first unit display mode circuit 322(d) outputs the voltage instruction signal CTRL(c) of the L level on the basis of no latch signal LAT(c).

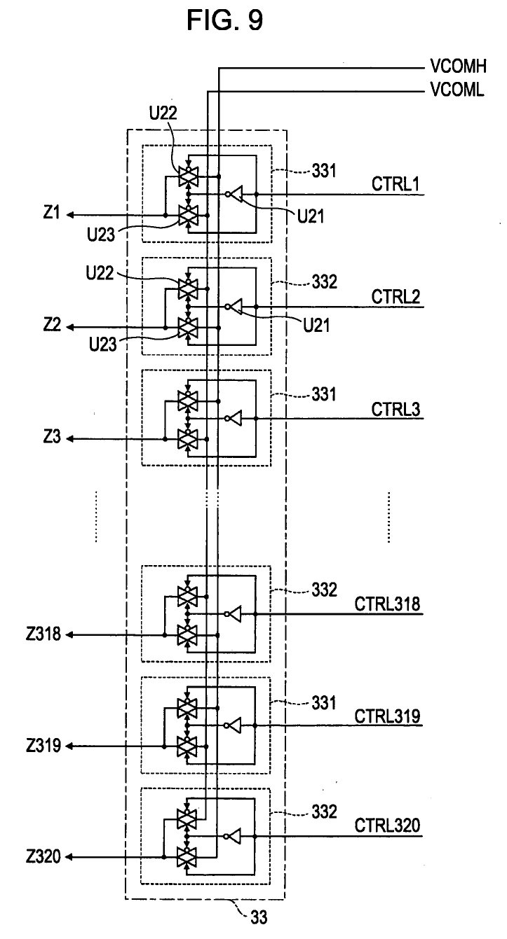

Subsequently, the voltage selection circuit 33 shown in FIG. 6 will be described. FIG. 9 is a block diagram illustrating a configuration of the voltage selection circuit 33.

As shown in FIG. 9, the voltage selection circuit 33 includes first unit voltage selection circuits 331 corresponding to the scanning lines Y of odd numbered rows and second unit voltage selection circuits 332 corresponding to the scanning lines Y of even numbered rows.

The first unit voltage selection circuits 331 will be described with reference to the first unit voltage selection circuit 331(e) corresponding to the scanning line Y(e) of an e-th row (where e is an odd number satisfying 1≦e≦319).

The first unit voltage selection circuit 331(e) of an odd numbered e-th row includes an inverter U21, a first transfer gate U22, and a second transfer gate U23. A voltage instruction signal CRTL(e) output from the display mode circuit 32 of the e-th row is input to an input terminal of the inverter U21, and a non-inverting input control terminal of the first transfer gate U22 and an inverting input control terminal of the second transfer gate U23 are connected to output terminal of the inverter U21.

The voltage VCOMH is input to an input terminal of the first transfer gate U22. The output terminal of the inverter U21 is connected to the non-inverting input control terminal of the first transfer gate U22. The voltage instruction signal CTRL(e) is input to an inverting input control terminal of the first transfer gate U22. The voltage VCOML is input to an input terminal of the second transfer gate U23. The output terminal of the inverter U21 is connected to the inverting input control terminal of the second transfer gate U23. The voltage instruction signal LATL(e) is input to a non-inverting input control terminal of the second transfer gate U23. Moreover, the output terminal of the first transfer gate U22 and the output terminal of the second transfer gate U23 are commonly connected to a common line Z(e) of the odd numbered e-th row.

For this reason, in the first unit voltage selection circuit 331(e) of the odd numbered e-th row, when the voltage instruction signal CTRL(e) is the H level, the first transfer gate U22 turns off and the second transfer gate U23 turns on. Accordingly, the voltage VCOML supplied to the input terminal of the second transfer gate U23 is output to the common line Z(e). Alternatively, when the voltage instruction signal CTRL(e) is the H level, the first transfer gate U22 turns on and the second transfer gate U23 turns off. Accordingly, the voltage VCOMH supplied to the input terminal of the first transfer gate U22 is output to the common line Z(e).

That is, when the voltage instruction signal CTRL(e) is the H level, the first unit voltage selection circuit 331(e) of the odd numbered e-th row supplies the voltage VCOML to the common line Z(e). Alternatively, when the instruction signal CTRL(e) is the L level, the first unit voltage selection circuit 331(e) of the odd numbered e-th row supplies the voltage VCOMH to the common line Z(e).

In this case, the voltage VCOMH and the voltage VCOML have relationship of VGL<VCOML<VCOMH<VGH about the voltages VGH and VGL applied to the scanning lines Y1 to Y320 (see FIG. 11, and the like).

Next, the second unit voltage selection circuits 332 will be described with reference to the second unit voltage selection circuit 332(f) corresponding to the scanning line Y(f) of an f-th row (where f is an even number satisfying 2≦f≦320).

The second unit voltage selection circuit 332(f) of an even numbered f-th row supplies the voltage VCOML supplied to the input terminal of the first transfer gate U22 and the voltage VCOMH supplied to the input terminal of the second transfer gate U23, compared to the first unit voltage selection circuit 331(e) of the odd numbered e-th row. The other configuration is the same as that of the first unit voltage selection circuit 331(e).

For this reason, when the voltage instruction signal CTRL(f) is the H level, the first unit voltage selection circuit 331(e) of the even numbered f-th row supplies the voltage VCOMH to the common line Z(e). Alternatively, when the voltage instruction signal CTRL(f) is the L level, the first unit voltage selection circuit 331(e) of the even numbered f-th row supplies the voltage VCOML to the common line Z(e).

Next, how the voltage of the common lines Z1 to Z320 is changed by the control circuit 30 in the entire screen display mode, will be described with reference to the change in the voltage of the scanning lines Y1 to Y320. FIG. 10 is a timing chart of the control circuit 30 in the entire screen display mode.

In the entire screen display mode, the display mode selection signal CENB is fixed as the H level. In the FIG. 10, the voltage VGH corresponds to the selection voltage (the H level) in the scanning lines Y1 to Y320 and the voltage VGL corresponds the non-selection voltage (the L level) in the scanning lines Y1 to Y320.

First, an operation of the control circuit 30 in the entire screen display mode will be described with reference to the common lines Z1 and Z320.

At time t1 which is a start timing of one frame period, the polarity signal POL is set to the L level. Then, the first unit latch circuit 311 of the 320-th row receives the polarity signal POL of the L level and outputs latch signals LAT1 and LAT320 of the L level. When the latch signal LAT1 of the L level is input, the first unit display mode circuit 321 of the 1st row outputs the voltage instruction signal CTRL1 of the H level to the first unit voltage selection circuit 331 of the 1st row. In addition, when the latch signal LAT320 of the L level is input, the second unit display mode circuit 322 outputs the voltage instruction signal CTRL320 of the H level to the second unit voltage selection circuit 332 of the 2nd row. Then, the first unit voltage selection circuit 331 of the 1st row supplies the voltage VCOML to the common line Z1 and the second unit voltage selection circuit 332 of the 320th row supplies the voltage VCOMH to the common line Z320. For this reason, at time t1, the voltage of the common line Z1 becomes the voltage VCOML and the common line Z320 becomes the voltage VCOMH.

Subsequently, when the one frame period lapses from time t1, and then time reaches time t4, which is a start timing of the next one frame period, the polarity signal POL is inverted to the H level. Then, the first unit latch circuits 311 provided so as to correspond to the 1st and 320th rows receive the polarity signal POL of the H level and output the latch signals LAT1 and LAT320 of the H level. When the latch signal LAT1 of the H level is input, all the first unit display mode circuits 321 of the 1st row output the voltage instruction signal CTRL1 of the L level to the first unit voltage selection circuits 331 of the 1st row. In addition, when the latch signal LAT320 of the H level is input, all the first unit display mode circuits 321 of the 320th row output the voltage instruction signal CTRL320 of the L level to the second unit voltage selection circuits 332 of the 320th row. Then, the first unit voltage selection circuit 331 of the 1st row supplies the voltage VCOMH to the common line Z1 and the second unit voltage selection circuit 332 of the 320th row supplies the voltage VCOML to the common line Z320. For this reason, at time t4, the voltage of the common line Z1 becomes the voltage VCOMH and the common line Z320 becomes the voltage VCOML.

Subsequently, when the one frame period lapses from time t4 again, and then time reaches time t7, which is the start timing of the next one frame period, the polarity signal POL is inverted to the L level.

Then, like time t1, the first unit voltage selection circuit 331 corresponding to the scanning line Y1 supplies the voltage VCOML to the common line Z1 and the second unit voltage selection circuit 332 corresponding to the scanning line Y320 supplies the voltage VCOMH to the common line Z320. For this reason, at time t7, the voltage of the common line Z1 becomes the voltage VCOML and the common line Z320 becomes the voltage VCOMH.

Next, the operation of the control circuit 30 will be described with reference to the common line Z2.

When the one horizontally scanning period lapses from time t1 and time reaches time t2, the scanning line driving circuit 10 supplies the selection voltage to the scanning line Y1, and thus the voltage of the scanning line Y1 becomes the voltage VGH.

From a viewpoint of the second unit latch circuit 312 of the 2nd row, since the selection voltage is applied to the scanning line Y1 which is the more previous scanning line by one line, the second unit latch circuit 312 of the 2nd row receives the polarity signal POL of the L level and outputs a latch signal LAT2 of the L level. When the latch signal LAT2 of the L level is input, the second unit display mode circuit 322 of the 2nd row outputs a voltage instruction signal CTRL2 of the H level to the second unit voltage selection circuit 332 of the 2nd row. Then, the second unit voltage selection circuit 332 of the 2nd row supplies the voltage VCOMH to the common line Z2. For this reason, the voltage of the common line Z2 becomes the voltage VCOMH at time t2.

When the one horizontally scanning period lapses from time t2 and time reaches time t3, the voltage of the scanning line Y1 becomes the voltage VGL, the voltage of the scanning line Y2 becomes the voltage VGH, and the voltage of the scanning lines Y1 and Y3 becomes the non-selection voltage. For this reason, from a viewpoint of the second unit latch circuit 312 of the 2nd row, since the voltage of the scanning line Y1, which is the more previous scanning line by one line, and the scanning line Y3, which is the later scanning line by one line, become the non-selection voltage, the second unit latch circuit 312 of the 2nd row holds and outputs the latch signal LAT2 of the L level, and thus the common line Z2 holds the voltage VCOMH.

With the one horizontally scanning period lapsed from time t3, the voltage of the scanning line Y2 becomes the voltage VGL and the voltage of the scanning line Y3 becomes the voltage VGH. For this reason, from a viewpoint of the second unit latch circuit 312 of the 2nd row, since the selection voltage is applied to the scanning line Y3, which is the right next row, the second unit latch circuit 312 of the 2nd row receives the polarity signal POL of the L level again and outputs the latch signal LAT2 of the L level. For this reason, the voltage of the common line Z2 becomes the voltage VCOMH.

When the voltage of the scanning line Y3 becomes the voltage VGH, and then the one horizontally scanning period lapses, the voltage of the scanning line Y3 becomes the voltage VGL. At this time, the voltage of the scanning line Y1 becomes the voltage VGL previously at time t3. For this reason, from a viewpoint of the second unit latch circuit 312 of the 2nd row, when the voltage of the scanning line Y2 becomes the voltage VGH, the second unit latch circuit 312 of the 2nd row holds and outputs the latch signal LAT2 of the L level in the same manner, and thus the common line Z2 holds the voltage VCOMH.

During the next frame period, the scanning line driving circuit 10 supplies the selection voltage to the scanning line Y1 and at time t5 when the voltage of the scanning line Y1 becomes the voltage VGH, the second unit latch circuit 312 of the 2nd row receives the polarity signal POL of the H level and outputs the latch signal LAT2 of the H level. When the latch signal LAT2 of the H level is input, the second unit display mode circuit 322 of the 2nd row outputs the voltage instruction signal CTRL2 of the L level to the second unit voltage selection circuit 332 of the 2nd row. Then, the second unit voltage selection circuit 332 corresponding to the scanning line Y2 supplies the voltage VCOML to the common line Z2. For this reason, at time t5, the voltage of the common line Z2 is changed from the voltage VCOMH to the voltage VCOML.

When the voltage of the common line Z2 is changed to the voltage VCOML, the common line Z2 holds the voltage VCOML during the next frame period until the voltage of the scanning line Y1 again becomes the voltage VGH, which is the selection voltage.

Next, the operation of the control circuit 30 will be described with reference to the common line Z3.

At time t3, when the voltage of the scanning line Y2 is the voltage VGH, the selection voltage is applied to the scanning line Y2 which is the more previous scanning line by one line than the scanning line Y3 from a viewpoint of the second unit latch circuit 312. Accordingly, the second unit latch circuit 312 of the 3rd row receives the polarity signal POL of the L level and outputs the latch signal LAT3 of the L level. When the latch signal LAT3 of the L level is input, the first unit display mode circuit 321 of the 3rd row outputs the voltage instruction signal CTRL3 of the H level to the first unit voltage selection circuit 331 of the 3rd row. Then, the first unit voltage selection circuit 331 of the 3rd row supplies the voltage VCOML to the common line Z3. For this reason, the voltage of the common line Z3 becomes the voltage VCOML at time t3. Moreover, the common line Z3 holds the voltage VCOML until the voltage of the scanning line Y2 becomes the voltage VGH again at time t6 of the next frame period.

At time t6 of the next frame period, when the voltage of the scanning line Y2 becomes the voltage VGH, the second unit latch circuit 312 of the 3rd row receives the polarity signal POL of the H level and outputs the latch signal LAT3 of the H level. When the latch signal LAT3 of the H level is input, the first unit display mode circuit 321 of the 3rd row outputs the voltage instruction signal CTRL3 of the L level to the first unit voltage selection circuit 331 of the 3rd row. Then, the first unit voltage selection circuit 331 of the 3rd row supplies the voltage VCOMH to the common line Z3. For this reason, at time t6, the voltage of the common line Z3 is switched from the voltage VCOML to the voltage VCOMH. When the voltage of the common line Z3 is inverted to the voltage VCOMH, the common line Z3 holds the voltage VCOMH until the voltage of the scanning line Y1 becomes the voltage VGH again during the subsequent frame period.

In this case, the operation of the control circuit 30 will be described with reference to the common line Z(g) (where g is an odd number satisfying 5≦g≦319) of the odd numbered rows except for the above-described common lines Z1 and Z3 among the common lines Z1 to Z320.

When the voltage VCOMH is supplied to the common line Z3 in synchronization with supply of the selection voltage to the scanning line Y2, the control circuit 30 supplies the voltage VCOMH to the common line Z(g) in synchronization with supply of the selection voltage to the scanning line Y(g−1) during the one frame period. Afterward, when the selection voltage is supplied again to the scanning line Y(g−1) during the next frame period, the common line Z(g) holds the voltage VCOML.

Alternatively, when the voltage VCOML is supplied to the common line Z3 in synchronization with supply of the selection voltage to the scanning line Y2, the control circuit 30 supplies the voltage VCOML to the common line Z(g) in synchronization with supply of the selection voltage to the scanning line Y(g−1) during the one frame period. Afterward, when the selection voltage is supplied again to the scanning line Y(g−1) during the next frame period, the common line Z(g) holds the voltage VCOMH.

Next, the operation of the control circuit 30 will be described with reference to the common lines Z(h) (where h is an even number satisfying 4≦h≦318) of the even numbered rows except for the above-described common lines Z2 and Z320 among the common lines Z1 to Z320.

When the voltage VCOMH is supplied to the common line Z2 in synchronization with supply of the selection voltage to the scanning line Y1, the control circuit 30 supplies the voltage VCOMH to the common line Z(h) in synchronization with supply of the selection voltage to the scanning line Y(h−1) during the one frame period. Afterward, when the selection voltage is supplied again to the scanning line Y(h−1) during the next frame period, the common line Z(h) holds the voltage VCOMH.

Alternatively, when the voltage VCOML is supplied to the common line Z2 in synchronization with supply of the selection voltage to the scanning line Y1, the control circuit 30 supplies the voltage VCOML to the common line Z(h) in synchronization with supply of the selection voltage to the scanning line Y(h−1) during the one frame period. Afterward, when the selection voltage is supplied again to the scanning line Y(h−1) during the next frame period, the common line Z(g) holds the voltage VCOMH.

That is, the voltage of the common lines are configured so as to be inverted from one of the voltages VCOMH and VCOML to the other of the voltages VCOMH and VCOML before (before one horizontally scanning period) time of applying the selection voltage to the corresponding scanning line.

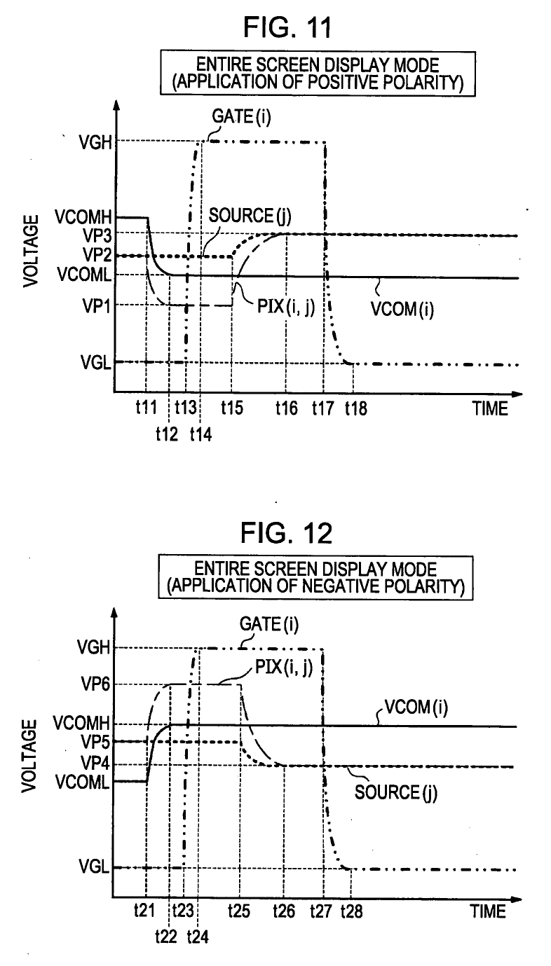

Next, an operation in the entire screen display mode of the liquid crystal device 1 having such a control circuit 30 will be described. In the entire screen display mode, FIG. 11 is a diagram illustrating a voltage waveform of each unit in the application of the positive polarity and FIG. 12 is a diagram illustrating a voltage waveform of each unit in the application of the negative polarity.

In FIGS. 11 and 12, GATE(i) denotes a voltage of the scanning line of an i-th row (where i is an integer satisfying 1≦i≦320) and SOURCE(j) denotes a voltage of the data line of a j-th row (where j is an integer satisfying 1≦j≦240). PIX(i, j) denotes a voltage of the pixel electrode 55 of a pixel 50 in the i-th row and the j-th column corresponding to an intersection of the i-th scanning line and the j-th data line. VCOM(i) denotes a voltage of the common line Z(i) of the i-th row.

First, an operation in the application of the positive polarity in the entire screen display mode will be described with reference to FIG. 11.

With the positive polarity applied, the control circuit 30 supplies the voltage VCOML to the common line Z(i) at time t1 before the voltage GATE(i) of the scanning line Y(i) of the i-th row. For this reason, the voltage VCOM(i) of the common line Z(i) gradually decrease from the voltage VCOMH to the voltage VCOML at time t12.

At time t11, the voltage GATE(i) of the scanning line Y(i) is the non-selection voltage VGL and the TFT 51 is in the OFF state. Accordingly, the data line X(j) of the j-th column and the pixel electrode 55 constituting the pixel 50 in the i-th row and the j-th column are not connected to each other. A capacitive coupling is made between the pixel electrode 55 constituting the pixel 50 in the i-th row and the j-th column and the common electrode 56 which is the common line Z(i) by a storage capacitor 53 and a pixel capacitor 54.

For this reason, the voltage PIX(i, j) of the pixel electrode 55 constituting the pixel 50 in the i-th row and the j-th column decreases so as to hold the potential difference between the voltage VCOM(i) and the voltage PIX(i, j), and then becomes the voltage VP1 at time t12.

Next, at time t13, the scanning line driving circuit 10 supplies the selection voltage to the scanning line Y(i). For this reason, the voltage GATE(i) of the scanning line Y(i) increases, and then becomes the voltage VGH at time t14. In this way, all the TFTs 51 of which the gates are connected to the scanning line Y(i) turn on.

At time t15 when the voltage GATE(i) of the scanning line Y(i) is the selection voltage VGH, the data line driving circuit 20 supplies the image signal having the positive polarity to the data line X(j). Then, the voltage SOURCE(j) of the data line X(j) increases to a voltage VP3 at time t16.

The voltage SOURCE(j) of the data line X(j), which is the image voltage on the basis of the image signal having the positive polarity, is applied to the pixel electrode 55 constituting the pixel 50 in the i-th row and the j-th column through the TFT 51 which is in the ON state and of which the gate is connected to the scanning line Y(i). For this reason, the PIX(i, j) of the pixel electrode 55 constituting the pixel 50 in the i-th row and the j-th column increases and becomes the voltage VP3 of which the potential is the same as that of the voltage SOURCE(j) of the data line X(j), at time t16.

At time t17, the scanning line driving circuit 10 switches the voltage applied to the scanning line Y (i) from the selection voltage to the non-selection voltage. Then, the voltage GATE(i) of the scanning line Y(i) decreases to the voltage VGL at time t18. In this way, all the TFTs 51 of which the gates are connected to the scanning line Y(i) turn off.

Moreover, even when the TFT 51 turns off, the pixel capacitor 54 holds the difference in potential between the voltage PIX(i, j) applied to the pixel electrode 55 and the voltage VCOM(i) of the common line Z(i) by the capacitance of the pixel capacitor 54 and the storage capacitor 53.

Next, an operation of the application of the negative polarity voltage in the entire screen display mode will be described with reference to FIG. 12.

With the positive polarity applied, the control circuit 30 supplies the voltage VCOMH to the common line Z(i) at time t21 before the voltage GATE(i) of the scanning line Y(i) of the i-th row. For this reason, the voltage VCOM(i) of the common line Z(i) gradually increases from the voltage VCOML to the voltage VCOML at time t22.

At time t21, the voltage GATE(i) of the scanning line Y(i) is the non-selection voltage VGL and the TFT 51 is in the OFF state. Accordingly, the data line X(j) of the j-th column and the pixel electrode 55 constituting the pixel 50 in the i-th row and the j-th column are not connected to each other. A capacitive coupling is made between the pixel electrode 55 constituting the pixel 50 in the i-th row and the j-th column and the common electrode 56 which is the common line Z(i) by a storage capacitor 53 and a pixel capacitor 54.

For this reason, the voltage PIX(i, j) of the pixel electrode 55 constituting the pixel 50 in the i-th row and the j-th column increases so as to hold the potential difference between the voltage VCOM(i) and the voltage PIX(i, j), and then becomes the voltage VP6 at time t22.

At time t23, the scanning line driving circuit 10 switches the voltage applied to the scanning line Y(i) from the non-selection voltage to the selection voltage. Then, the voltage GATE(i) of the scanning line Y(i) increases, and then becomes the voltage VGH at time t24. In this way, all the TFTs 51 of which the gates are connected to the scanning line Y(i) turn on.

At time t25 when the voltage GATE(i) of the scanning line Y(i) is the selection voltage VGH, the data line driving circuit 20 supplies the image signal having the negative polarity to the data line X(j). Then, the voltage SOURCE(j) of the data line X(j) decreases to a voltage VP4 at time t26.

The voltage SOURCE(j) of the data line X(j), which is the image voltage on the basis of the image signal having the negative polarity, is applied to the pixel electrode 55 constituting the pixel 50 in the i-th row and the j-th column through the TFT 51 which is in the ON state and of which the gate is connected to the scanning line Y(i). For this reason, the PIX(i, j) of the pixel electrode 55 constituting the pixel 50 in the i-th row and the j-th column decreases and becomes the voltage VP4 of which the potential is the same as that of the voltage SOURCE(j) of the data line X(j), at time t26.

At time t27, the scanning line driving circuit 10 switches the voltage applied to the scanning line Y (i) from the selection voltage to the non-selection voltage. Then, the voltage GATE(i) of the scanning line Y(i) decreases to the voltage VGL at time t28. In this way, all the TFTs 51 of which the gates are connected to the scanning line Y(i) turn off.

Moreover, even when the TFT 51 turns off, the pixel capacitor 54 holds the difference in potential between the voltage PIX(i, j) applied to the pixel electrode 55 and the voltage VCOM(i) of the common line Z(i) by the capacitance of the pixel capacitor 54 and the storage capacitor 54.

Next, an operation of the control circuit 30 in the partial screen display mode will be described. FIG. 13 is a diagram illustrating an operation of the control circuit 30 in the partial screen display mode and illustrating how the voltage of the common lines is changed when selecting the scanning lines.

Moreover, in the partial screen display mode, the display mode selection signal CEMB is in the L level from the time of applying the selection voltage to the scanning line which is the more previous scanning line by one line than the start row in the non-display area 82 to the time of finishing the application of the selection voltage to the scanning line of the last row in the non-display area 82. In addition, during the other period, the display mode selection signal CEMB is in the H level. In a first embodiment, the pixels 50 associated with the display area 81 are in the 1st row to 25th row and the pixels 50 associated with the non-display area 82 are in the 26th row to the 320th row. Accordingly, as shown in FIG. 13, the display mode selection signal CENB is in the L level from time t35 to time t37 and from time 41 to time 43.

Moreover, the display mode selection signal CENB may be configured so as to be changed to the L level from time of applying the selection voltage to the scanning line of the start row in the non-display area 82.

First, the operation of the control circuit 30 will be described in the partial screen display mode with reference to the common lines Z1.

At time t31 which is a start timing of one frame period, the polarity signal POL is set to the L level. At time t31, since the display mode selection signal CENB is in the H level, the first unit voltage selection circuit 331 of the 1st row supplies the voltage VCOML to the common line Z1, like time t1 shown in FIG. 10. For this reason, the voltage of the common line Z1 becomes the voltage VCOML.

At time t35, when the display mode selection signal CENB becomes the L level, the first unit display mode circuit 321 of the 1st row outputs the voltage instruction signal CTRL1 of the H level to the first unit voltage selection circuit 331 of the 1st row. Accordingly, the first unit voltage selection circuit 331 of the 1st row supplies the voltage VCOML to the common line Z1 as a predetermined voltage. For this reason, the common line Z1 holds the voltage VCOML.

At time t37 which is a start timing of the next frame period, the polarity signal POL is set to the H level. At time t37, since the display mode selection signal CENB is in the H level, the first unit voltage selection circuit 331 of the 1st row supplies the voltage VCOMH to the common line Z1, like time t4 shown in FIG. 10. For this reason, the voltage of the common line Z1 becomes the voltage VCOMH.

At time t41, when the display mode selection signal CENB becomes the L level, the first unit display mode circuit 321 of the 1st row outputs the voltage instruction signal CTRL1 of the H level to the first unit voltage selection circuit 331 of the 1st row. Accordingly, the first unit voltage selection circuit 331 of the 1st row supplies the voltage VCOML to the common line Z1 as the predetermined voltage. For this reason, the common line Z1 holds the voltage VCOML.

Moreover, at time t43 which is the start timing of the subsequent frame period, the polarity signal POL is set to the L level. At time t43, since the display mode selection signal CENB is in the H level, the first unit voltage selection circuit 331 of the 1st row supplies the voltage VCOML to the common line Z1, like time t7 shown in FIG. 10. For this reason, the voltage of the common line Z1 holds the voltage VCOML.

Next, the operation of the control circuit 30 will be described with reference to the common line Z2.

When the one horizontally scanning period lapses from time t31 and time reaches time t32, the scanning line driving circuit 10 supplies the selection voltage to the scanning line Y1, and thus the voltage of the scanning line Y1 becomes the voltage VGH. At this time t32, since the display mode selection signal CENB is in the H level, the second unit voltage selection circuit 332 of the 2nd row supplies the voltage VCOMH to the common line Z2. For this reason, the voltage of the common line Z2 becomes the voltage VCOMH.

At time t35, when the display mode selection signal CENB becomes the L level, the second unit display mode circuit 322 of the 2nd row outputs the voltage instruction signal CTRL2 of the L level to the second unit voltage selection circuit 332 of the 2nd row. Accordingly, the second unit voltage selection circuit 332 of the 2nd row supplies the voltage VCOML to the common line Z2 as the predetermined voltage. For this reason, the voltage of the common line Z2 becomes the voltage VCOML.

At time t38 of the subsequent frame period, when the voltage of the scanning line Y1 becomes the voltage VGH, the display mode selection signal CENB is in the H level at time t38. Accordingly, like time t5 shown in FIG. 10, the second unit voltage selection circuit 332 of the 2nd row supplies the voltage VCOML to the common line Z2. For this reason, the common line Z1 holds the voltage VCOML.

At time t41, when the display mode selection signal CENB becomes the L level, the first unit display mode circuit 322 of the 2nd row outputs the voltage instruction signal CTRL2 of the L level to the second unit voltage selection circuit 331 of the 2nd row. Accordingly, the second unit voltage selection circuit 332 of the 2nd row supplies the voltage VCOML to the common line Z2 as the predetermined voltage. For this reason, the common line Z2 holds the voltage VCOML.

Next, the operation of the control circuit 30 will be described with reference to the common line Z3.

When the one horizontally scanning period lapses from time t32 and time reaches time t33, the scanning line driving circuit 10 supplies the selection voltage to the scanning line Y2, and thus the voltage of the scanning line Y1 becomes the voltage VGH. At this time t33, since the display mode selection signal CENB is in the H level, the voltage VCOML is supplied to the common line Z3 like time t3 shown in FIG. 10. For this reason, the voltage of the common line Z3 becomes the voltage VCOML.

At time t35, when the display mode selection signal CENB becomes the L level, the first unit display mode circuit 321 of the 3rd row outputs the voltage instruction signal CTRL3 of the H level to the first unit voltage selection circuit 331 of the 3rd row. Accordingly, the first unit voltage selection circuit 331 of the 3rd row supplies the voltage VCOML to the common line Z3 as the predetermined voltage. For this reason, the common line Z3 holds the voltage VCOML.

At time t39 of the subsequent frame period, when the voltage of the scanning line Y2 becomes VGH, the display mode selection signal CENB is in the H level. Accordingly, like time t6 shown in FIG. 10, the first unit voltage selection circuit 331 of the 3rd row supplies the voltage VCOMH to the common line Z3. For this reason, the voltage of the common line Z3 becomes the voltage VCOMH.

At time t41, when the display mode selection signal CENB becomes the L level, the first unit display mode circuit 321 of the 3rd row outputs the voltage instruction signal CTRL3 of the H level to the first unit voltage selection circuit 331 of the 3rd row. Accordingly, the first unit voltage selection circuit 331 of the 3 rd row supplies the voltage VCOML to the common line Z3 as the predetermined voltage. For this reason, the voltage of the common line Z3 becomes the voltage VCOML.

Next, the operation of the control circuit 30 will be described with reference to the common lines Z(k) (where k is an odd number satisfying 5≦k≦25) of the even numbered rows except for the above-described common lines Z1 and Z3 among the common lines Z1 to Z25 corresponding to the 1st row to the 25th row associated with the display area 81.

When the voltage VCOMH is supplied to the common line Z3 in synchronization with supply of the selection voltage to the scanning line Y2, the control circuit 30 supplies the voltage VCOMH to the common line Z(k) in synchronization with supply of the selection voltage to the scanning line Y(k−1). Alternatively, when the voltage VCOML is supplied to the common line Z3 in synchronization with supply of the selection voltage to the scanning line Y2, the control circuit 30 supplies the voltage VCOML to the common line Z(k) in synchronization with supply of the selection voltage to the scanning line Y(k−1). Moreover, the control circuit 30 supplies the voltage VCOML to the common line Z(k) as the predetermined voltage in synchronization with time when the display mode selection signal CENB becomes the L level.

Subsequently, the operation of the control circuit 30 will be described with reference to the common line Z(m) (where m is an even number satisfying 4≦m≦24) of the even numbered rows except for the above-described common line Z2 among the common lines Z1 to Z25 corresponding to the 1st row to 25th row associated with the display area 81.

When the voltage VCOMH is supplied to the common line Z2 in synchronization with supply of the selection voltage to the scanning line Y1, the control circuit 30 supplies the voltage VCOMH to the common line Z(m) in synchronization with supply of the selection voltage to the scanning line Y(m−1) during the one frame period. Alternatively, when the voltage VCOML is supplied to the common line Z2 in synchronization with supply of the selection voltage to the scanning line Y1, the control circuit 30 supplies the voltage VCOML to the common line Z(m) in synchronization with supply of the selection voltage to the scanning line Y(m−1) during the one frame period. Moreover, the control circuit 30 supplies the voltage VCOML to the common line Z(m) as the predetermined VCOML in synchronization with time when the display mode selection signal CENB becomes the L level.

Next, the operation of the control circuit 30 will be described with reference to the common lines Z26 to Z320 corresponding to the 26th row to 320th row associated with the non-display area 82.

First, the operation of the control circuit 30 will be described with reference to the common line Z26 of the 26th row in the uppermost line in the non-display area 82. The operation is the same as that of the common line Z(m) of the even numbered row in the above-described display area 81. That is, when the voltage VCOMH is supplied to the common line Z2 in synchronization with supply of the selection voltage to the scanning line Y1, the control circuit 30 supplies the voltage VCOMH to the common line Z26 in synchronization with supply of the selection voltage to the scanning line Y25 during the one frame period. Alternatively, when the voltage VCOML is supplied to the common line Z2 in synchronization with supply of the selection voltage to the scanning line Y1, the control circuit 30 supplies the voltage VCOML to the common line Z26 in synchronization with supply of the selection voltage to the scanning line Y25 during the one frame period. Moreover, the control circuit 30 supplies the voltage VCOML to the common line Z26 as the predetermined VCOML in synchronization with time when the display mode selection signal CENB becomes the L level.

Subsequently, the operation of the control circuit 30 will be described with reference to the common line Z(n) (where n is an integer satisfying 27≦n≦320) generalized for the above-described common lines Z27 to Z320 except for the 26th row, which is placed in the uppermost line.

Since all the display mode selection signals CENB are in the L level at time of supplying the selection voltage to the scanning line Y(n−1) and at time of supplying the selection voltage to the scanning line Y(n+1), the control circuit 30 continues to supply the voltage VCOML to the common line Z(n).

Next, an operation in the partial screen display mode of the liquid crystal device 1 having such a control circuit 30 will be described.

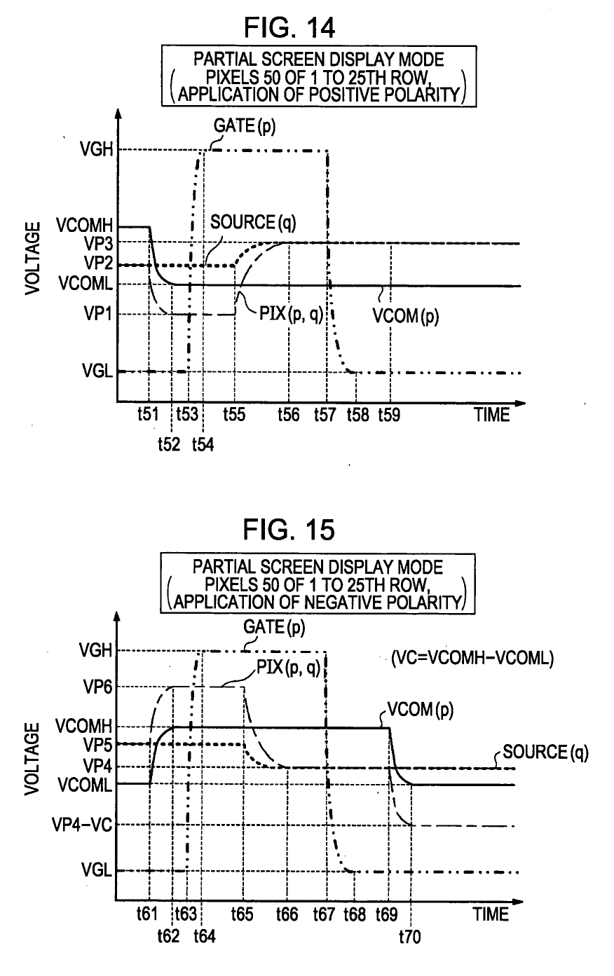

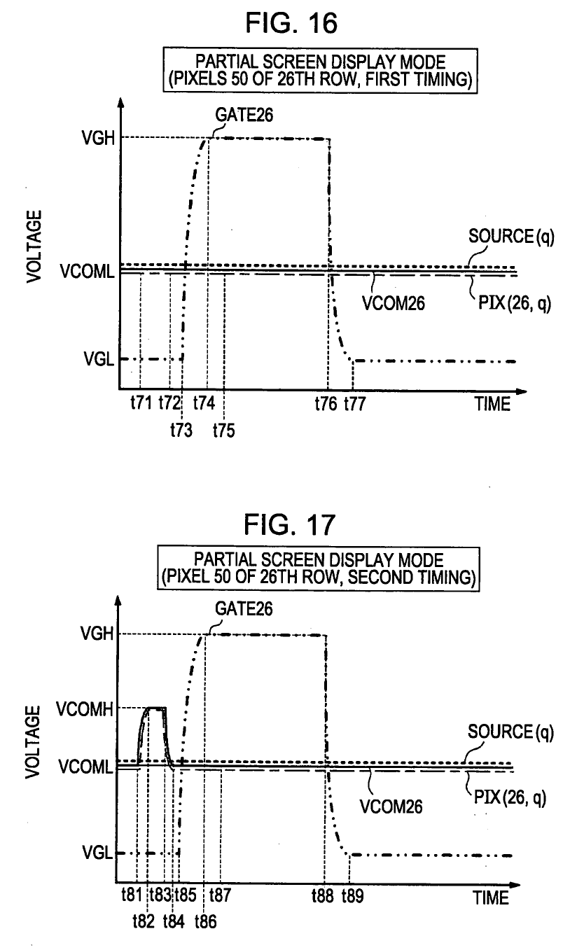

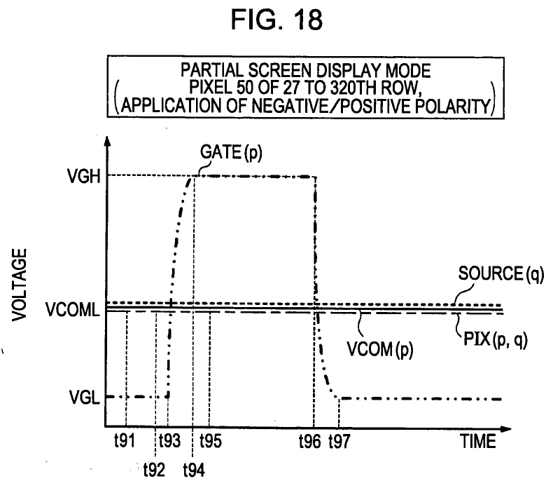

When the voltage is applied to the pixels 50 in the 1st row to 25th row associated with the display area 81 in the partial screen display mode of the liquid crystal device 1, FIG. 14 is a diagram illustrating a voltage waveform of each unit in the application of the positive polarity and FIG. 15 is a diagram illustrating the voltage waveform of each unit in the application of the negative polarity. FIGS. 16 and 17 are diagrams illustrating the voltage waveform of each unit when the voltage is applied to the pixels 50 in the 26th row which is placed in the uppermost line in the non-display area 82 in the partial screen display mode. FIG. 18 is a diagram illustrating the voltage waveform of each unit when the voltage is applied to pixels 50 of the 25th row to 320th row except for the 26th row associated with the non-display area in the partial screen display mode.

In FIGS. 14 and 18, GATE(p) denotes a voltage of the scanning line of an p-th row (where p is an integer satisfying 1≦p≦320) and SOURCE(q) denotes a voltage of the data line of a q-th row (where q is an integer satisfying 1≦q≦240). PIX(p, q) denotes a voltage of the pixel electrode 55 of a pixel 50 in the p-th row and the q-th column corresponding to an intersection of the p-th scanning line and the q-th data line. VCOM(p) denotes a voltage of the common line Z(p) of the p-th row.

First, an operation in the application of the positive polarity to the pixels 50 of the 1st to 25th row associated with the display area 81 in the partial screen display mode will be described with reference to FIG. 14.

The description about the period from time t51 to time t58 will be omitted since the description is the same as that about the period from time t11 to time t18. As shown in FIG. 14, time t59 is the one frame period which is the same as the period from time t51 to time t58 and is timing when the display ode selection signal CENB becomes the L level.

At time t59, when the display mode selection signal CENB becomes the L level, the control circuit 30 supplies the voltage VCOML to the common line z(q) as the predetermined voltage. Since the voltage of the common line z(p) is the voltage VCOML from time t51 to time t58, the voltage of the common line Z(p) holds the voltage VCOML.

Moreover, at time t59, since the selection voltage is not supplied to the scanning line Y(p), the data line X(q) of the q-th column and the pixel electrode 55 constituting the pixel 50 in the p-th row and the q-th column are not connected to each other. A capacitive coupling occurs between the pixel electrode 55 constituting the pixel 50 in the p-th row and the q-th column and the common line Z(p). For this reason, the voltage PIX(p, q) of the pixel electrode 55 constituting the pixel 50 in the p-th row and the q-th column holds the voltage VP3 so as to hold the potential difference between the voltage VCOM(p) and the voltage PIX(p, q).

Next, the operation in the application of the negative polarity voltage to the pixels 50 in the 1st row to 25th row associated with the display area in the partial screen display mode will be described with reference to FIG. 15.

The description about the period from time t61 to time t68 will be omitted since the description is the same as that about the period from time t21 to time t28. As shown in FIG. 15, time t69 is the one frame period which is the same as the period from time t61 to time t68 and is timing when the display mode selection signal CENB becomes the L level.

At time t69, when the display mode selection signal CENB becomes the L level, the control circuit 30 supplies the voltage VCOML to the common line z(p) as the predetermined voltage. Since the voltage VCOM(p) of the common line z(p) decreases to the voltage VCOML at time t70.

At time t69, since the selection voltage is not supplied to the scanning line Y(p), the data line X(q) of the q-th column and the pixel electrode 55 constituting the pixel 50 in the p-th row and the q-th column are not connected to each other. In addition, a capacitive coupling occurs between the pixel electrode 55 constituting the pixel 50 in the p-th row and the q-th column and the common line Z(p). For this reason, the voltage PIX(p, q) of the pixel electrode 55 constituting the pixel 50 in the p-th row and the q-th column decreases so as to hold the potential difference between the voltage VCOM(p) and the voltage PIX(p, q), and then becomes a voltage (VP4−VC) at time t70. At this time, the voltage VC is equal to a voltage as many as the voltage VCOM(p) of the common line Z(p) decreases, that is, a voltage (VCOMH−VCOML) during a period from time t69 to time t70.

Subsequently, an operation in application to the pixels 50 in the 26th row to 320th row associated with the non-display area 82 in the partial screen display mode of the liquid crystal device 1 will be described by dividing the pixels into the pixel 50 of the 26th row and the pixels 50 of the 27th to 320th row.

First, the operation in the application to the pixel 50 of the 26th row will be described.

FIG. 16 is a diagram illustrating the voltage waveform of each unit in the application to the pixel 50 of the 26th row in the partial screen display mode. In particular, FIG. 16 shows the application during the one frame period which is the same as the period when the voltage VCOML is supplied to the common line Z2 in synchronization with supply of the selection voltage to the scanning line Y1 (a first timing). Moreover, in FIG. 16, time t72 is timing when the display mode selection signal CENB becomes the L level and corresponds to time t41 shown in FIG. 13.

At time t71, in synchronization with supply of the selection voltage to the scanning line Y25 which is the more previous scanning line by one line than the 26th row, the control circuit 30 supplies the voltage VCOML to the common line Z26. At this time, since the voltage of the common line Z26 is the voltage VCOML as well during the previous period of time t71, the voltage VCOM26 of the common line Z26 maintains the voltage VCOML at time t71.

At time t71, since the selection voltage is not supplied to the scanning line Y26, the data line X(q) of the q-th column and the pixel electrodes 55 having the pixels 50 of the q-th column are not connected to each other. The capacitive coupling occurs between the pixel electrode 55 constituting the pixel 50 in the 26th row and the q-th column and the common line Z26.

For this reason, the voltage PIX(26, q) of the pixel electrode 55 constituting the pixel 50 in the 26th row and q-th column holds the voltage VCOML in order to hold the potential difference between the voltage VCOM(26) and the voltage PIX(26, q).

At time t72, when the display mode selection signal CENB becomes the L level, the control circuit 30 supplies the voltage VCOML to the common line Z26 as the predetermined voltage. In this case, since the voltage of the common line Z26 is the voltage VCOML even during the period from time t71 to time t72, the voltage of the common line Z26 does not vary and holds the voltage VCOML.

At time t72, since the selection voltage is not supplied to the scanning line Y26, the data line X(q) of the q-th column and the pixel electrode 55 constituting the pixel 50 in the 26th row and the q-th column are not connected to each other. In addition, the capacitive coupling occurs between the pixel electrode 55 constituting the pixel 50 in the 26th row and the q-th column and the common line Z26. For this reason, the voltage PIX(26, q) of the pixel electrode 55 constituting the pixel 50 in the 26th row and q-th column holds the voltage VCOML in order to hold the potential difference between the voltage VCOM(26) and the voltage PIX(26, q).

At time t73, when the scanning line driving circuit 10 supplies the selection voltage to the scanning line Y26, the voltage GATE26 of the scanning line Y26 increases to the voltage VGH at time t74. In this way, all the TFTs 51 connected to the scanning line Y26 turn on.

Meanwhile, at time t75, the partial circuit 40 supplies the voltage VCOML to the data line X(q) as the predetermined voltage. Then, the voltage SOURCE(q) of the data line X(q) becomes the voltage VCOML.

The voltage SOURCE(q) of the data line X(q) is applied to the pixel electrode 55 having the pixel in the 26th row and the q-th column through the TFTs 51 which is in the ON state and connected to the scanning line Y26. For this reason, the voltage PIX(26, q) of the pixel electrode 55 constituting the pixel 50 in the 26th row and the q-th column becomes the voltage VCOML of which the potential is the same as that of the SOURCE(q) of the data line X(q).

In this case, since the voltage VCOM26 of the common electrode Z26 becomes the voltage VCOML, the difference in voltage between the pixel electrode 55 and the common electrode 56 in the pixel capacitor 54 is zero. For this reason, the pixel 50 in the 26th row and the q-th column becomes a black display which is in an OFF state of the normally black mode.

At time 76, the scanning line driving circuit 10 switches the voltage applied to the scanning line Y26 from the selection voltage to the non-selection voltage. Then, the voltage GATE26 of the scanning line Y26 decreases to the voltage VGL at time t77. In this way, all the TFTs 51 of which the gates are connected turn off.

Moreover, even when the TFTs 51 turn off, the pixel electrode 54 holds the difference in voltage of zero by the capacitance of the pixel electrode 54 and the storage capacitor 53.

FIG. 17 is a diagram illustrating the voltage waveform of each unit in the application to the pixel 50 of the 26th row in the partial screen display mode. In particular, FIG. 17 shows the application during the one frame period which is the same as the period when the voltage VCOMH is supplied to the common line Z2 in synchronization with supply of the selection voltage to the scanning line Y1 (a second timing). Moreover, in FIG. 17, time t83 is timing when the display mode selection signal CENB becomes the L level and corresponds to time t35 shown in FIG. 13.

At time t81, when the control circuit 30 supplies the voltage VCOMH to the common line Z26 in synchronization with supply of the selection voltage to the scanning line Y25, the voltage VCOM26 of the common line Z26 gradually increases to the voltage VCOMH at time t82.

At time t81, since the selection voltage is not supplied to the scanning line Y26, the data line X(q) of the q-th column and the pixel electrode 55 constituting the pixel 50 in the 26th row and the q-th column are not connected to each other. In addition, the capacitive coupling occurs between the pixel electrode 55 constituting the pixel 50 in the 26th row and the q-th column. For this reason, the voltage PIX(26, q) of the pixel electrode 55 constituting the pixel 50 in the 26th row and q-th column increases so as to hold the potential difference (zero) between the voltage VCOM(26) and the voltage PIX(26, q).

At time t83, when the display mode selection signal CENB becomes the L level, the control circuit 30 supplies the voltage VCOML to the common line Z26 as the predetermined voltage. For this reason, the voltage VCOM26 of the common line Z26 gradually decreases to the voltage VCOML at time t84.

At time t83, since the selection voltage is not supplied to the scanning line Y26, the data line X(q) of the q-th column and the pixel electrode 55 constituting the pixel 50 in the 26th row and the q-th column are not connected to each other. In addition, the capacitive coupling occurs between the pixel electrode 55 constituting the pixel 50 in the 26th row and the q-th column. For this reason, the voltage PIX(26, q) of the pixel electrode 55 constituting the pixel 50 in the 26th row and q-th column decreases so as to hold the potential difference (zero) between the voltage VCOM(26) and the voltage PIX(26, q), and then becomes the voltage VCOML at time t84.

Moreover, during a period from time t85 to time t89 shown in FIG. 17, the operation is performed in the same way during the period from time t73 to time t77 shown in FIG. 16.

Next, an operation in the application to the pixels 50 of the 27th row to 320th row will be described.

FIG. 18 is a diagram illustrating operation in the application to the pixels 50 of the 27th row to 320th row in the partial screen display mode. In the partial screen display mode, the common lines Z27 to Z320 of the 27th row to 320th row hold the voltage VCOML irrespective of the logic level of the polarity signal POL. When the selection voltage is sequentially applied to the scanning lines of the 27th row to the 320th row, the partial circuit 40 supplies the voltage VCOML of which is the same as that of the common lines to the data lines of the 1st column to the 240th column. Accordingly, the difference in voltage of the pixel capacitor 54 holds to be zero in the pixels 50 of the 27th row to 320th row associated with the non-display area, and then the pixels 50 of the 27th row to 320th row become the black display which is in the OFF state of the normally black mode.

That is, during a period from time t91 to time t97 shown in FIG. 18, the operation is carried out in the same way during the period from time t71 to time t77 shown in FIG. 16.

The following advantages according to this embodiment are as follows.

(1) Since the voltage VCOML is supplied to the common lines (the common electrode 56), and then the positive polarity is applied and the voltage VCOMH is supplied to the common electrode 56, and then the negative polarity is applied, the charges do not move like the above-described known example, from a viewpoint of all rows in the entire screen display mode and the rows associated with the display area 81 in the partial screen display mode. For this reason, even when irregularity in characteristic happens in the storage capacitors 53, it is difficult for deterioration in the voltage to occur. As a result, the irregularity can be prevented in a brightness of each pixel 50, thereby preventing a display quality from deteriorating.

(2) The control circuit 30 has the first unit latch circuit 311 or the second unit latch circuit 312 included by the latch circuit 31, the first unit display mode circuit 321 or the second unit display mode circuit 322 included by the display mode circuit 32, and the first unit voltage selection circuit 331 or the second unit voltage selection circuit 332 included by the voltage selection circuit 33 in correspondence to the scanning line of the 320th row. Accordingly, it is possible to selectively supply the voltage VCOML or the voltage VCOMH to the common line (the common electrode 56) of each row.

Moreover, how any one of the voltage VCOML and the voltage VCOMH is applied to the common line of each row depends on the applied polarity. For this reason, like the known example described above, it is not necessary to change the voltage of each capacitance line connected to one electrode of each storage capacitor 53 differently from the voltage of the each pixel electrode 55 and each common electrode 56 included by the corresponding pixel capacitor 54. That is, in this embodiment, since the voltage of the one electrode of each storage capacitor 53 can be changed similarly with the voltage of each common electrode 56, the one electrode of each storage capacitor 53 and each common electrode 56 can be incorporated. Moreover, since the other electrode of each storage capacitor 53 is connected to the corresponding pixel electrode 55, as described above, the potential of the other electrode of each storage capacitor 53 is the same as that of the corresponding pixel electrode 55, and thus the other electrode of each storage capacitor 53 and the corresponding pixel electrode 55 can be incorporated.

As a result, it is possible to embody the liquid crystal device which is referred to as IPS or FFS in which the storage capacitors 53 and the pixel electrodes 54 are incorporated on an element substrate 60 of the element substrate 60 and a counter substrate 70 with the liquid crystal interposed therebetween.

(3) The common lines (the common electrodes 56) hold the voltage VCOML as a predetermined voltage, in each row of the non-display area 82 in the partial screen display mode, and then with the selection voltage applied to the scanning lines, the voltage VCOML is supplied to the data lines as the predetermined voltage. That is, after the voltage of the common lines becomes the voltage VCOML, the voltage VCOML is applied to the pixel electrodes 55. Accordingly, the voltage of the common electrodes 56 and the pixel electrodes 55 becomes the voltage VCOML, the driving voltage is not applied to the liquid crystal. That is, since the driving voltage is not applied to the liquid crystal in the non-display area 82 in the partial screen display mode, it is possible to reduce the consumption power.

(4) The positive polarity and the negative polarity are applied to every row by partitioning the common electrode 56 every row, and simultaneously by supplying the voltage VCOML and the voltage VCOMH to the common electrodes of all rows in the entire screen display mode and the common electrodes of the rows associated with the display area 81 every row. Accordingly, since the pixels 50 in which the positive polarity is applied and the pixels 50 in which the negative polarity is applied exist together, such pixels 50 can compensate flicker. As a result, it is possible to prevent the display quality from deteriorating.

### Improvement and Application of First Embodiment

In the above-described first embodiment, an improvement and application is possible as follows.

### Predetermined Voltage

In the first embodiment described above, the control circuit 30 supplies the voltage VCOML to the common lines Z1 to X320 as the predetermined voltage and the partial circuit 40 supplies the voltage VCOML to the data lines X1 to X240 as the predetermined voltage, but it is not limited thereto. For example, the control circuit 30 may supply the voltage VCOMH to the common lines Z1 to Z320 as the predetermined voltage and the partial circuit 40 may supply the voltage VCOMH to the data lines X1 to X240 as the predetermined voltage.

### Two-Way Direction and One-Way Direction

In the first embodiment described above, the selection voltage is applied to the scanning lines in the sequential order of Y1, Y2, Y3, . . . , Y319, Y320. However, the selection voltage may be applied in the reverse order of Y320, Y319, . . . , Y1.

When the selection voltage is applied to the scanning lines in the reverse order, the transmission circuit of the stages corresponding to some rows in the shift register 11 shown in FIG. 5 may be configured in the manner that the output signal is set to be the input signal of the transmission circuit of the stage corresponding to one row and the start pulse YD is set to be the input signal of the transmission circuit of the 320 stages.

Moreover, the configuration of the control circuit 30 may be used without modification of the configuration. The reason is why the latch circuit 31 shown in FIG. 7 has a configuration in which the output signal of the NOR circuit U1 becomes the L level so as to receive and output the polarity signal POL as the latch signal when one of the more previous and later scanning lines than the corresponding scanning lines becomes the H level in the second unit latch circuit 312 corresponding to the rows except for the 1st row and 320th row, the output signal of the NOR circuit U1 becomes the L level.

Conversely, in the control circuit 30, it is not required that the application order of the selection voltage to the scanning lines corresponds to a two-way direction, that is, a direction from the 1st row to the 320th row and a direction from the 320th row to the 1st row. For example, when it is sufficient to correspond to the direction from the 1st row to 320th row, the control circuit may be configured in the manner that the NOR circuit U1 is omitted in the first unit latch circuit 311 and the second unit latch circuit 312 of the latch circuit 31 and the connection of the inverting input terminal and the non-inverting input may be exchanged with each other, compared in FIG. 7, in the first clocked inverter U4 and the second clocked inverter U5 in order to ensure consistency of the negative logic configuration in correspondence with the omission of the NOR circuit U1. In addition, in the 320th row, the second unit latch circuit 312 is set.

According to the above-described configuration, when the scanning line of the 1st row becomes the H level, it is possible to receive the polarity signal POL and output it as the latch signal. As a result, it is possible to simplify the circuit configuration as the NOR circuit U1 is omitted.

### Voltage Selection Circuit

In the voltage selection circuit 33 shown in FIG. 9, the relatively high voltage VCOMH is supplied to the input terminal of the transfer gate U22 in each first unit voltage selection circuit 331 and the input terminal of the transfer gate U23 in each second unit voltage selection circuit 332. In addition, the relatively low voltage VCOML is supplied to the input terminal of the transfer gate U23 in each first unit voltage selection circuit 331 and the input terminal of the transfer gate U22 into each second unit voltage selection circuit 332.

In this embodiment, the transfer gates U22 and U23 are assumed to have a configuration in which a p-channel type transistor and an n-channel type transistor are connected in parallel in that the inverting control input terminal and the non-inverting control input terminal turn on and off by means of a logic level. However, since the voltage supplied to the input terminals is fixed, both the channel transistors are not required to be connected in parallel to each other and any one of the channel transistors may be the channel type transistor.

That is, as a simple n-channel type transistor, the transfer gate U22 in each first unit voltage selection circuit 331 and the transfer gate U23 in each second unit voltage selection circuit 332 may supply the voltage VCOMH to the source electrodes so as to connect the drain electrodes to the common lines and may supply a signal for inverting the voltage instruction signal of the inverter U21 is supplied to the gate electrode. Alternatively, as a simple p-channel type transistor, the transfer gate U23 in each first unit voltage selection circuit 331 and the transfer gate U22 in each second unit voltage selection circuit 332 may supply the voltage VCOML to the source electrodes so as to connect the drain electrodes to the common lines and may supply the voltage instruction signal to the gate electrode.

Moreover, even when transfer gate is used or even when one channel-type transistor is used, it is desirable that the channel length of the transistor connected to the voltages VCOMH and VCOML is shorter than that of the other transistors.

### Change and Fixation of Display Area and Non-Display Area

In the above-described embodiment, the pixels 50 associated with the display area 81 are set to be placed in the 1st row to 25th row and the pixels 50 associated with the non-display area 82 are set to be placed in the 26th row to 320th row. However, the allocation of the rows associated with the display area 81 and the non-display area 82 is not limited thereto. For example, the pixels 50 associated with the display area 81 may be set to be placed in the later half rows of the 161st row to the 320th row and the pixels 50 associated with the non-display area 82 may be set to be placed in the first half of the 1st row to the 160th row of the rows. In this way, when the display area 81 is set to be placed in the 161st row to the 320th row and the non-display area 82 is set to be placed in the 1st row to the 160th row, in the application of the selection voltage to the scanning lines Y1 to Y320, the display mode selection signal CENB may be set to be the L level from time after the start time (time t31 and t37 as shown in FIG. 13) of the one frame period and before start time (time t32 and time t38 shown in FIG. 13) of applying the selection voltage to the scanning line Y1 to time of finishing the application of the selection voltage to the scanning line Y160 during the one frame period.

Moreover, the display area 81 and the non-display area 82 may not be changed, but may be fixed. That is, the display area 81 like the first embodiment may be fixed in the 1st row to the 25th row and the non-display area 82 may be fixed in the 26th row to the 320th row.

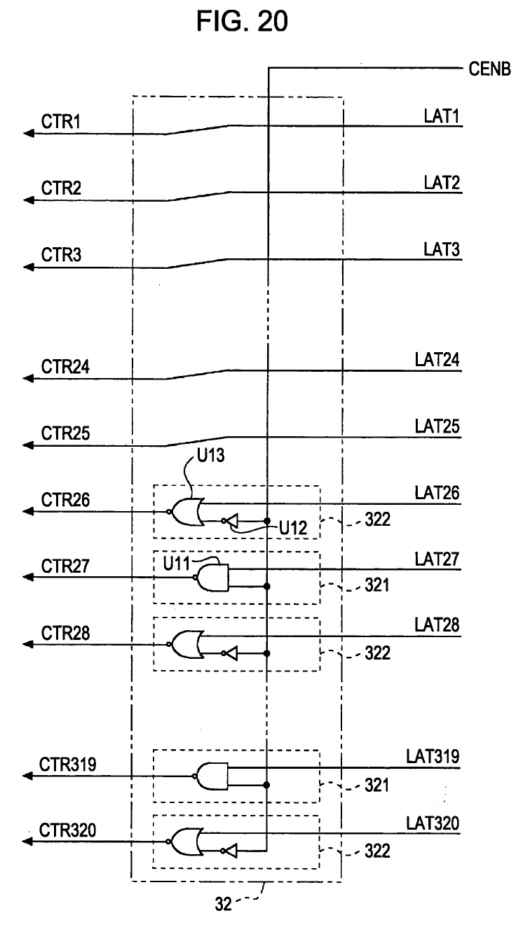

When the display area 81 and the non-display area 82 are fixed, as shown in FIG. 20, it is not required that the latch signals LAT1 to LAT25 corresponding to the 1st row to 25th row fixed in the display area 81 and the display mode selection signal CENB are configured so as to carry out logical operation in the display mode circuit 32. Moreover, even when the display area 81 and the non-display area 82 are fixed, in the 26th row to 320th row in which the non-display is fixed, it is required to maintain the display mode selection signal CENB and the configuration for carrying out the logical operation, as shown in FIG. 20. That is why the display mode selection signal CENB becomes the H level in the entire screen display mode.

Namely, in the rows associated with the display area 81, the first unit latch circuit 311 or the second unit latch circuit 312 in the latch circuit 31 and the first unit voltage selection circuit 331 or the second unit voltage selection circuit 332 in the voltage selection circuit 33 may constitute the first unit selection circuit. In addition, in the rows associated with the non-display area 82, the first unit display mode circuit 321 or the second unit display mode circuit 322 in the display mode circuit 32 may be added so as to constitute the second unit selection circuit.

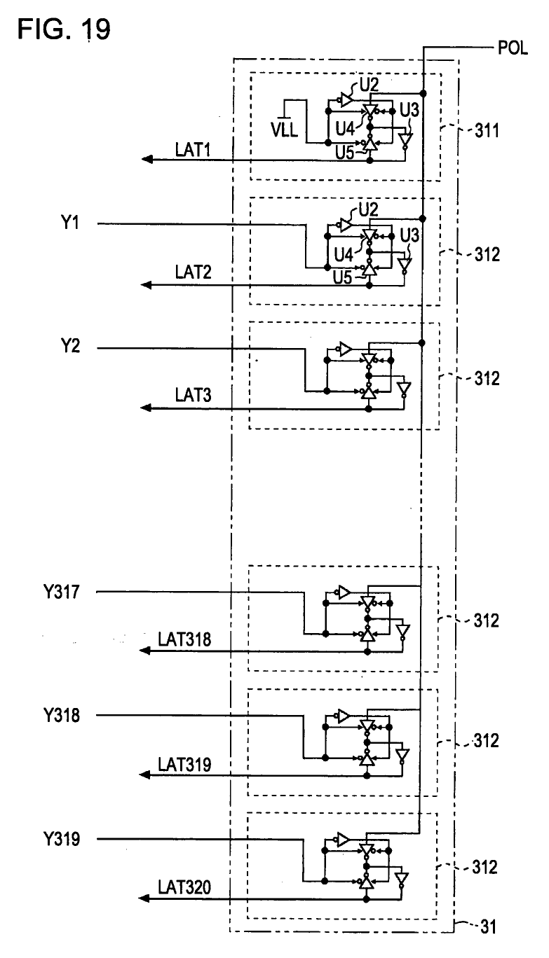

Moreover, when the display area 81 and the non-display area 82 are fixed, the configuration shown in FIG. 19 corresponding to the one-way direction may be applied to the latch circuit 31 in addition to the configuration shown in FIG. 7 corresponding to the two-way direction.

### Second Embodiment

A liquid crystal device according to a second embodiment of the invention will be described.

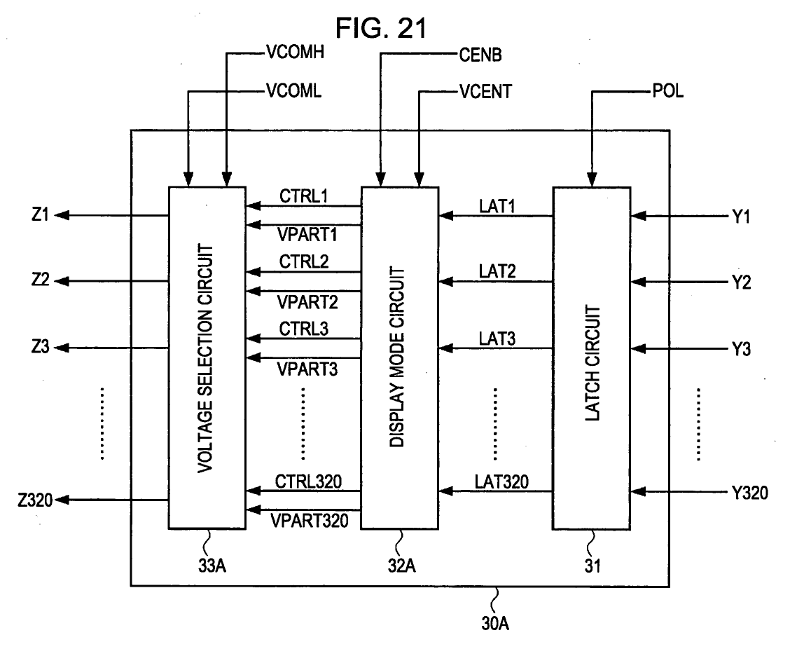

The liquid crystal device according to the second embodiment has a modified circuit configuration of the control circuit 30 (see FIG. 6) according to the first embodiment. FIG. 21 is a block diagram illustrating a configuration of the modified control circuit 30A.

When the selection voltage is applied to the scanning lines associated with the non-display area 82 in the partial display mode, a partial circuit 40 according to the second embodiment supplies a voltage VCENT to the data lines X1 to X240 as a predetermined voltage. Moreover, the other configurations are the same as those according to the first embodiment and the description is omitted.

As shown in FIG. 21, the control circuit 30A includes the latch circuit 31 which is the same as that according to the first embodiment, but includes a display mode circuit 32A and a voltage selection circuit 33A which have a different circuit configuration.

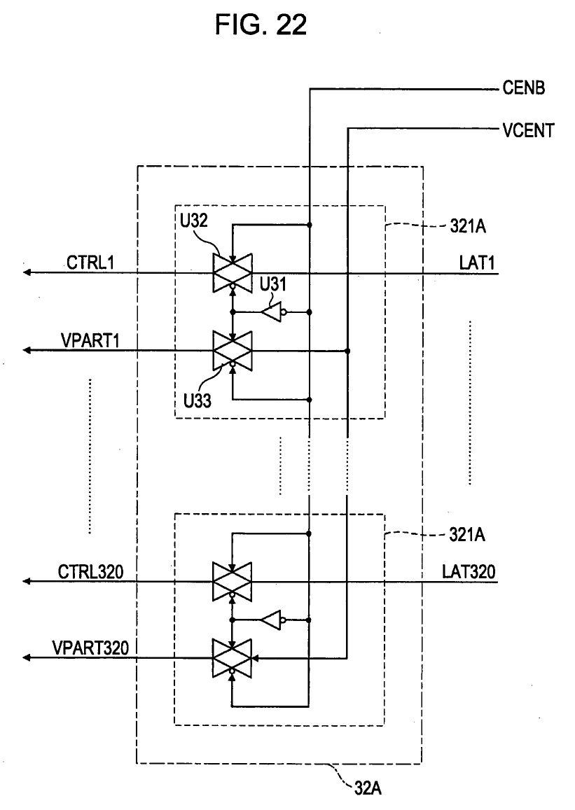

First, the display mode circuit 32A will be described. FIG. 22 is a block diagram illustrating a configuration of the display mode circuit 32A.

As shown in FIG. 22, the display mode circuit 32A includes unit display mode circuits 321A provided so as to correspond to the scanning lines Y1 to Y320. Each unit display mode circuit 321A includes an inverter U31, a first transfer gate U32, and a second transfer gate U33.

The display mode selection signal CENB is input to an input terminal of each inverter U31 and an output terminal of the inverter U31 is connected to an inverting input control terminal of the first transfer gate U32 and a non-inverting input control terminal of the second transfer gate U33.

The latch signal LAT output from the latch circuit 31 of the same row is input to an input terminal of the first transfer gate U32. In addition, the output terminal of the inverter U31 is connected to a non-inverting input control terminal of the first transfer gate U32 and the display mode selection signal CENB is input to the non-inverting input control terminal of the first transfer gate U32.

The voltage VCENT is input to an input terminal of the second transfer gate U33 as the predetermined voltage. At this time, the voltage VCENT is a middle voltage between the voltage VCOML and the voltage VCOMH. In addition, the display mode selection signal CENB is input to the non-inverting input control terminal of the second transfer gate U33 and the output terminal of the inverter U31 is connected to the non-inverting input control terminal of the second transfer gate U33.

In each unit display mode circuit 321A having such a configuration, when the display mode selection signal CENB of the H level is input, the display mode selection signal CENB of the H level is input to the non-inverting input control terminal of the first transfer gate U32, and simultaneously the polarity thereof is converted to the L level by the inverter U31 so as to be input to the non-inverting input control terminal of the first transfer gate U32. For this reason, the first transfer gate U32 turns on, and then the latch signal LAT input to the input terminal of the first transfer gate U32 in the ON state is output as the voltage instruction signal CTRL.

Alternatively, when the display mode selection signal CENB of the L level is input, the display mode selection signal CENB of the L level is input to the non-inverting input control terminal of the second transfer gate U33, and simultaneously the polarity thereof is converted to the H level by the inverter U33 so as to be input to the non-inverting input control terminal of the second transfer gate U33. For this reason, the second transfer gate U33 turns on, and then the voltage VCENT input to the input terminal of the second transfer gate U33 in the ON state as the predetermined voltage is output as a signal VPART.

Each unit display mode circuit 321A, as described above, outputs the latch signal LAT as the voltage instruction signal CTRL when the display mode selection signal CENB is the H level and outputs the voltage VCENT, which is the predetermined voltage, as the signal VPART when the display mode selection signal CENB is the L level. That is, each unit display mode circuit 321A exclusively outputs the voltage instruction signal CRTL and the signal VPART which is the voltage VCENT of the predetermined voltage.

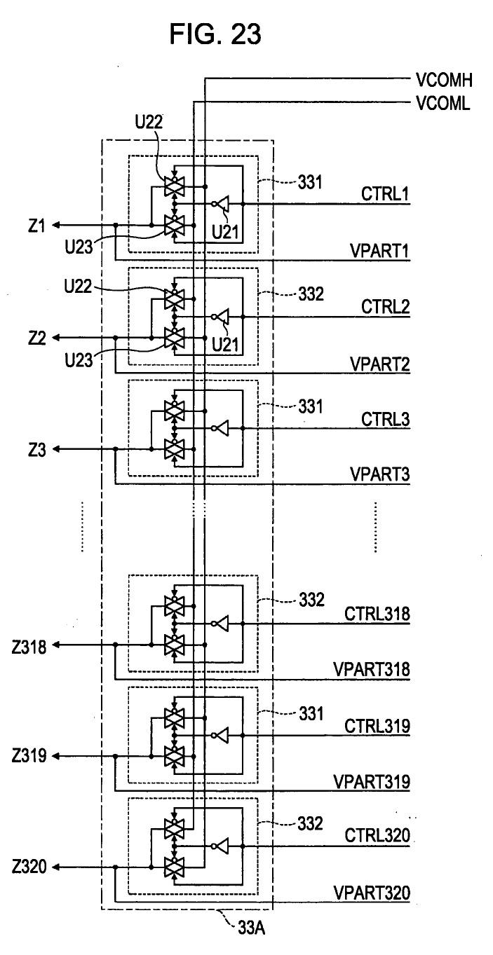

Next, the voltage selection circuit 33A shown in FIG. 21 will be described. FIG. 23 is a block diagram illustrating a configuration of the voltage selection circuit 33A.

As shown in FIG. 23, the voltage selection circuit 33A includes the first unit voltage selection circuits 331 provided so as to correspond to the odd numbered rows and the second unit voltage selection circuits 332 provided so as to correspond to the even numbered rows in the same way according to the first embodiment (see FIG. 9). However, signal lines to which the signal VPART of the same rows is supplied are connected to the common lines of the odd numbered rows in addition to the output terminals of the first unit voltage selection circuits 331 of the same rows and signal lines to which the signal VPART of the same rows is supplied are connected to the common lines of the even numbered rows in addition to the output terminals of the second unit voltage selection circuits 332 of the same rows.

The voltage selection circuit 33A operates as follows.

That is, in terms of the odd numbered r-th row (where r is an odd number satisfying 1≦r≦319), the voltage selection circuit 33A supplies the voltage VCOML to the common lines Z(r) of the odd numbered r-th rows when the display mode circuit 32A inputs the voltage instruction signal CTRL(r) of the H level and supplies the voltage VCOMH to the common lines Z(r) when the display mode circuit 32A inputs the voltage instruction signal CTRL(r) of the L level. Moreover, the voltage selection circuit 33A supplies the voltage VCENT to the common lines Z(r) when the display mode circuit 32A inputs a VPART(r) which is the voltage VCENT of the predetermined voltage.

Alternatively, in terms of the even numbered s-th row (where s is an even number satisfying 2≦s≦320), the voltage selection circuit 33A supplies the voltage VCOMH to the common lines Z(s) of the even numbered s-th rows when the display mode circuit 32A inputs the voltage instruction signal CTRL(s) of the H level and supplies the voltage VCOMH to the common lines Z(s) when the display mode circuit 32A inputs the voltage instruction signal CTRL(s) of the L level. Moreover, the voltage selection circuit 33A supplies the voltage VCENT to the common lines Z(s) when the display mode circuit 32A inputs a VPART(s) which is the voltage VCENT of the predetermined voltage.

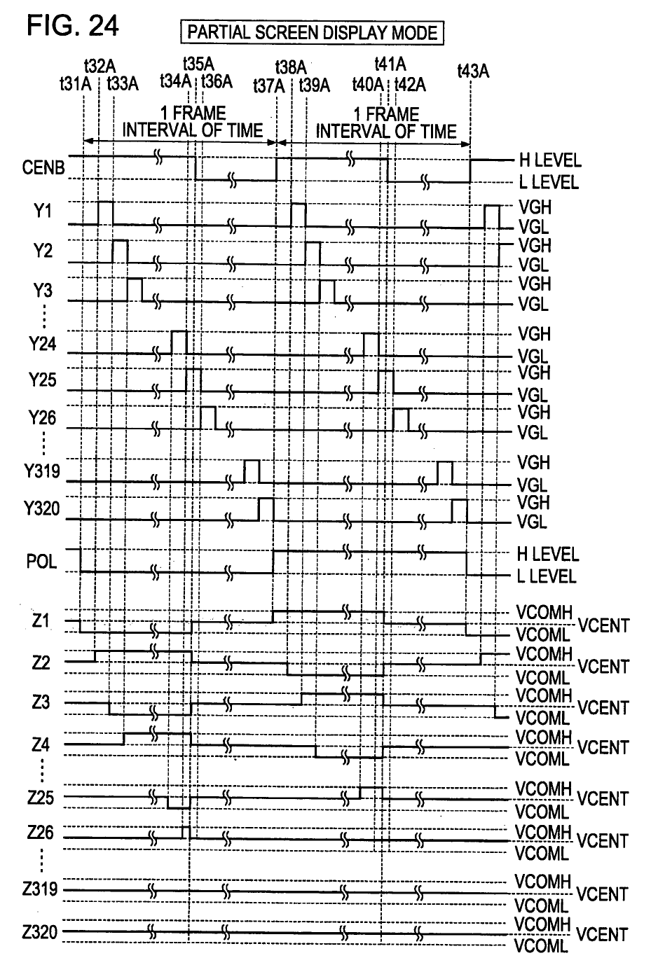

Such a control circuit 30A operates in the same way that the control circuit 30 (see FIG. 10) according to the first embodiment operates. For this reason, the control circuit 30A will be described in terms of the operation in the partial display mode. FIG. 24 is a diagram illustrating an operation of the control circuit 30A in the partial display mode and showing how the voltage of the common lines varies in the selection of the scanning lines.

Moreover, in the second embodiment, the pixels 50 associated with the display area 81 are set to be placed in the 1st row to 25th row and the pixels 50 associated with the non-display area 82 are set to be placed in the 26th row to the 320th row. As shown in FIG. 24, the display mode selection signal CENB is in the L level from time t35A to time t37A and from time t41A to time t43A.

The control circuit 30 according to the first embodiment, as shown in FIG. 13, supplies the voltage VCOML to the common lines as the predetermined voltage from time t35 to time t37 and from time t41 to time t43 (that is, period when the display mode selection signal CENB becomes the L level) in the partial screen display mode.

Meanwhile, the control circuit 30A according to the second embodiment, as shown in FIG. 24, supplies the voltage VCENT to the common lines as the predetermined voltage during time when the display mode selection signal CENB becomes the L level.

An operation of the liquid crystal device having such a control circuit 30A in the partial screen display mode will be described.

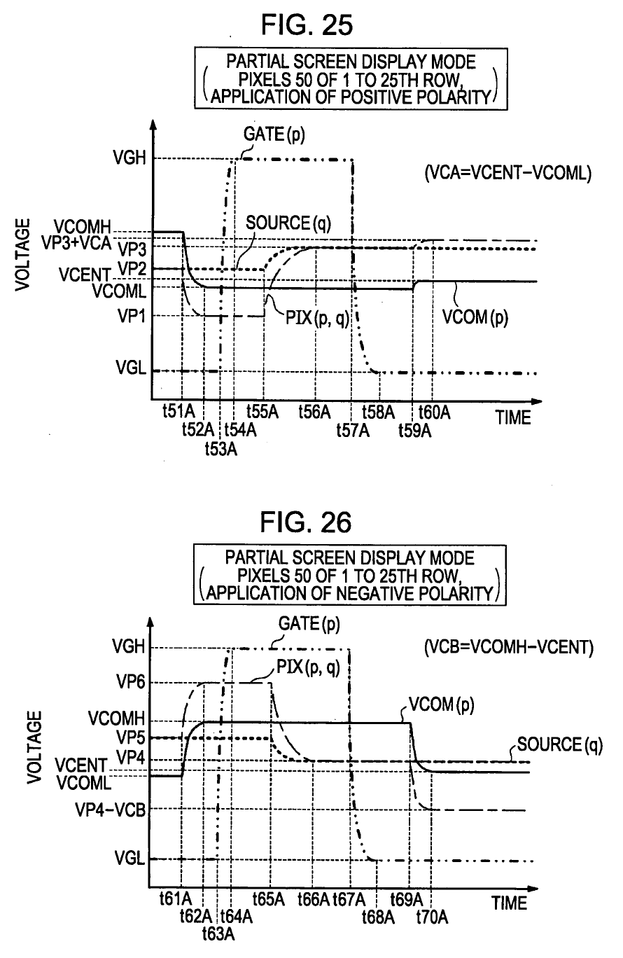

When the voltage is applied to the pixels 50 in the 1st row to the 25th row associated with the display area 81 in the partial display mode according to the second embodiment, FIG. 25 is a diagram illustrating a voltage waveform of each unit in the application of the positive polarity and FIG. 26 is a diagram illustrating the voltage waveform of each unit in the application of the negative polarity.

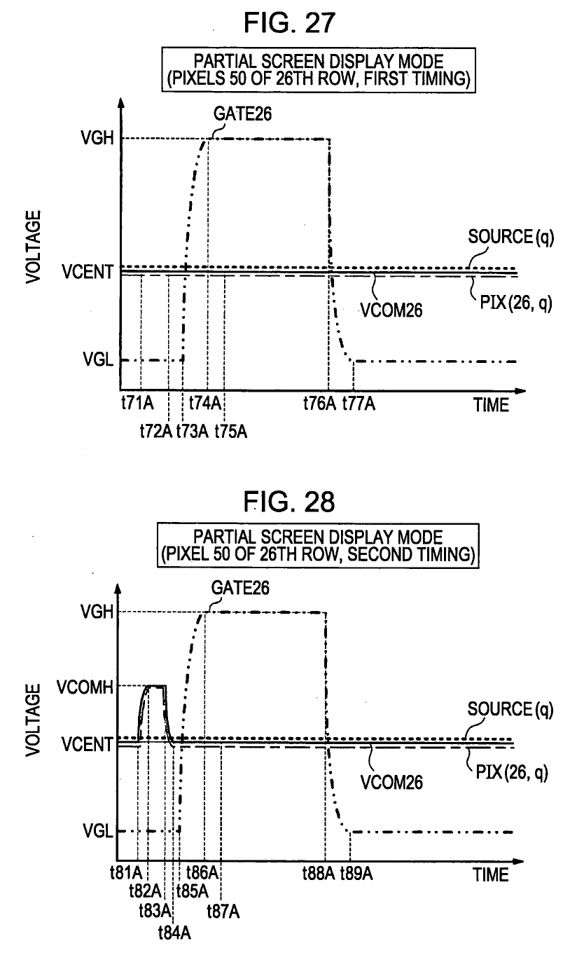

FIGS. 27 and 28 are diagrams illustrating the voltage waveform of each unit when the voltage is applied to the pixels 50 in the 26th row, which is placed in the uppermost row in the non-display area 82, in the non-display area 82. FIG. 28 is a diagram illustrating the voltage waveform of each unit when the voltage is applied to the pixels 50 of the 25th row to 320th row associated with the non-display area except for the 26th row in the partial screen display mode.

First, an operation in the application of the positive polarity to the pixels 50 in the 1st row to the 25th row associated with the display area in the partial screen display mode will described with reference to FIG. 25.

The operation from time t51A to time t59A is carried out in the same way as the operation from time t51 to time t59 shown in FIG. 14.

At time t59A, when the control circuit 30A supplies the voltage VCENT to the common line Z(p) as the predetermined voltage in synchronization with time when the display mode selection signal CENB becomes the L level, the voltage VCOM(p) of the common line Z(p) gradually increases to the voltage VCENT at time t60A.

At time t59A, since the selection voltage is not supplied to the scanning line Y(p), the data line X(q) of the q-th column and the pixel electrode 55 constituting the pixel 50 in the p-th row and the q-th column are not connected to each other. A capacitive coupling occurs between the pixel electrode 55 constituting the pixel 50 in the p-th row and the q-th column and the common electrode 56 connected to the common line Z(p). For this reason, the voltage PIX(p, q) of the pixel electrode 55 constituting the pixel 50 in the p-th row and the q-th column increases to the voltage (VP3+VCA) at time t60A so as to hold the potential difference between the voltage VCOM(p) and the voltage PIX(p, q). In this case, the voltage VCA is the same as the voltage VCOM(p) of the common electrode 56 connected to the common line Z(p) increases from time t59A to time t60A, that is, the voltage (VCENT−VCOML).

Next, the operation in the application of the negative polarity voltage to the pixels 50 in the 1st row to 25th row in the partial screen display mode will be described with reference to FIG. 26.

The operation is carried out from time t61A to time t69A in the same way as the operation from time t61 to time t69 shown in FIG. 15.

At time t69A, when the control circuit 30A supplies the voltage VCENT to the common line z(p) as the predetermined voltage in synchronization with time when the display mode selection signal CENB becomes the L level, the voltage VCOM(p) of the common electrode 56 connected to the common line z(p) gradually decreases to the voltage VCENT at time t70A.

At time t69A, since the selection voltage is not supplied to the scanning line Y(p), the data line X(q) of the q-th column and the pixel electrode 55 constituting the pixel 50 in the p-th row and the q-th column are not connected to each other. In addition, a capacitive coupling occurs between the pixel electrode 55 constituting the pixel 50 in the p-th row and the q-th column and the common electrode 56 connected to the common line Z(p). For this reason, the voltage PIX(p, q) of the pixel electrode 55 constituting the pixel 50 in the p-th row and the q-th column decreases so as to hold the potential difference between the voltage VCOM(p) and the voltage PIX(p, q), and then becomes a voltage (VP4−VCB) at time t70. At this time, the voltage VCB is equal to a voltage as much as the voltage VCOM(p) of the common line Z(p) decreases, that is, a voltage (VCOMH−VCENT) during a period from time t69 to time t70.

Subsequently, an operation in application to the pixels of the 26th row to 320th row associated with the non-display area 82 in the partial screen display mode according to the second embodiment will be described by dividing the pixels into the pixel of the 26th row and the pixels of the 27th to 320th row.

First, the operation in the application to the pixel 50 of the 26th row will be described.

FIG. 27 is a diagram illustrating the voltage waveform of each unit in the application to the pixel 50 of the 26th row in the partial screen display mode. In particular, FIG. 27 shows the application during the one frame period which is the same as the period when the voltage VCOML is supplied to the common line Z2 in synchronization with supply of the selection voltage to the scanning line Y1 (a first timing). Moreover, in FIG. 27, time t72A is timing when the display mode selection signal CENB becomes the L level and corresponds to time t41A shown in FIG. 22.

At time t71A, in synchronization with supply of the selection voltage to the scanning line Y25 which is the more previous scanning line by one line than the 26th row, the control circuit 30A supplies the voltage VCENT to the common line Z26. At this time, since the voltage of the common line Z26 is the voltage VCENT as well before the previous period of time t71A, the voltage VCOM26 of the common line Z26 holds the voltage VCOML at time t71A.

At time t71A, since the selection voltage is not supplied to the scanning line Y26, the data line X(q) of the q-th column and the pixel electrodes 55 having the pixels 50 of the q-th column are not connected to each other. The capacitive coupling occurs between the pixel electrode 55 constituting the pixel 50 in the 26th row and the q-th column and the common line Z26.

For this reason, the voltage PIX(26, q) of the pixel electrode 55 constituting the pixel 50 in the 26th row and q-th column holds the voltage VCENT in order to hold the potential difference between the voltage VCOM(26) and the voltage PIX(26, q).

At time t72A, when the display mode selection signal CENB becomes the L level, the control circuit 30 supplies the voltage VCENT to the common line Z26 as the predetermined voltage. In this case, since the voltage of the common line Z26 is the voltage VCENT even during the period from time t71A to time t72A, the voltage of the common line Z26 does not vary and holds the voltage VCENT.

At time t72A, since the selection voltage is not supplied to the scanning line Y26, the data line X(q) of the q-th column and the pixel electrode 55 constituting the pixel 50 in the 26th row and the q-th column are not connected to each other. In addition, the capacitive coupling occurs between the pixel electrode 55 constituting the pixel 50 in the 26th row and the q-th column and the common line Z26. For this reason, the voltage PIX(26, q) of the pixel electrode 55 constituting the pixel 50 in the 26th row and q-th column holds the voltage VCENT in order to hold the potential difference between the voltage VCOM(26) and the voltage PIX(26, q).

At time t73A, when the scanning line driving circuit 10 supplies the selection voltage to the scanning line Y26, the voltage GATE26 of the scanning line Y26 increases to the voltage VGH at time t74A. In this way, all the TFTs 51 connected to the scanning line Y26 turn on.

Meanwhile, at time t75A, the partial circuit 40 supplies the voltage VCENT to the data line X(q) as the predetermined voltage. Then, the voltage SOURCE(q) of the data line X(q) becomes the voltage VCENT.

The voltage SOURCE(q) of the data line X(q) is applied to the pixel electrode 55 having the pixel in the 26th row and the q-th column through the TFTs 51 which is in the ON state and connected to the scanning line Y26. For this reason, the voltage PIX(26, q) of the pixel electrode 55 constituting the pixel 50 in the 26th row and the q-th column becomes the voltage VCENT of which the potential is the same as that of the SOURCE(q) of the data line X(q).

In this case, since the voltage VCOM26 of the common electrode Z26 becomes the voltage VCENT, the difference in voltage between the pixel electrode 55 and the common electrode 56 in the pixel capacitor 54 is zero. For this reason, the pixel 50 in the 26th row and the q-th column becomes a black display which is in an OFF state of the normally black mode. Moreover, the operation during the period from time t76A to time t77A is the same as that during the period from time t76 to time t77 shown in FIG. 16 except for substituting the voltage VCENT for the voltage VCOML.

FIG. 28 is a diagram illustrating the voltage waveform of each unit in the application to the pixel 50 of the 26th row in the partial screen display mode according to the second embodiment. In particular, FIG. 28 shows the application during the one frame period which is the same as the period when the voltage VCOMH is supplied to the common line Z2 in synchronization with supply of the selection voltage to the scanning line Y1 (a second timing). Moreover, the operation during the period from time t81A to time t89A is the same as that during the period from time t81 to time t89 shown in FIG. 17 except for substituting the voltage VCENT for the voltage VCOML.

Next, an operation in the application to the pixels 50 of the 27th row to 320th row will be described.

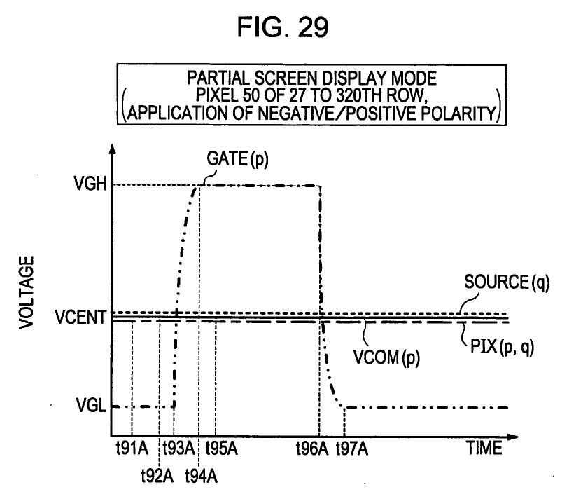

FIG. 29 is a diagram illustrating operation in the application to the pixels 50 of the 27th row to 320th row in the partial screen display mode according to the second embodiment. In the partial screen display mode, the common lines Z27 to Z320 of the 27th row to 320th row hold the voltage VCENT as shown in FIG. 24. When the selection voltage is sequentially applied to the scanning lines of the 27th row to 320th row, the partial circuit 40 supplies the voltage VCOML of which is the same as that of the common lines to the data lines of the 1st column to 240th column. The difference in voltage of the pixel capacitor 54 is held to be zero in the pixels 50 of the 27th row to 320th row associated with the non-display area, and then the pixels 50 of the 27th row to 320th row become the black display which is in the OFF state of the normally black mode.

That is, during a period from time t91A to time t97A shown in FIG. 29, the operation is carried out in the same way during the period from time t71A to time t77A shown in FIG. 27.

The advantages according to the second embodiment can be gained like the advantages according to the first embodiment described above.

In the second embodiment described above, as the predetermined voltage, the voltage VCENT is set to be the middle voltage between the voltage VCOML and the voltage VCOMH, but is not limited thereto. For example, the voltage VCENT may have the same potential as that of any one of the voltage VCOML and the voltage VCOMH.

### Third Embodiment

Next, a liquid crystal device according to a third embodiment of the invention will be described.

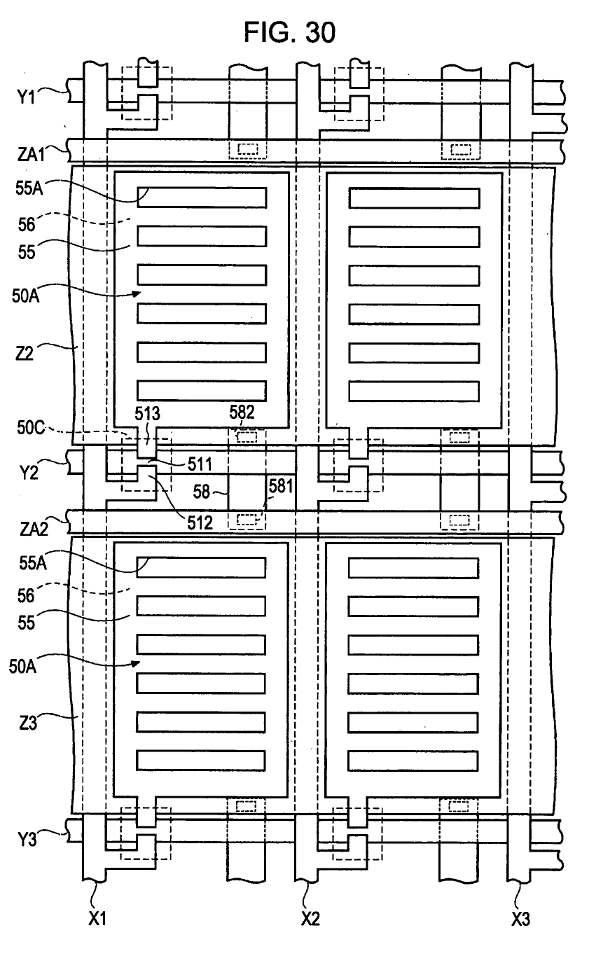

In the liquid crystal device according to the third embodiment, the pixels 50 (see FIG. 3) according to the first embodiment are modified. FIG. 30 is an exploded top view illustrating a configuration of each pixel 50A according to the third embodiment. The pixels 50A according to the third embodiment is different from the pixels 50 according to the first embodiment in that each pixel 50A includes a supplementary common line ZA and a contact wiring 58. The other configurations are the same as those according to the first embodiment, and the description will be omitted.

The supplementary common lines ZA are formed of conductive metal and are provided in correspondence with the common electrodes 56 (the common lines) partitioned every horizontal line. The supplementary common lines ZA are formed along the scanning lines Y. Specifically, the supplementary common lines ZA are formed along a direction of the scanning lines between the corresponding scanning lines and the common electrodes 56 of the lines which is below the scanning lines by one line.

The contact wirings 58 are formed of a conductive film and connected to the supplementary common lines ZA in areas 581. In addition, the contact wirings 58 are connected to the common electrodes 56 (the common lines) in areas 582.

As described above, the common electrodes 56 are configured by transparent electrodes. Accordingly, resistivity is relatively high and time constant is likely to increase. However, according to the third embodiment, the common electrodes 56 of each row are connected in parallel to the supplementary common lines ZA. Accordingly, since combined resistance is lowered, it is possible to reduce the time constant of the common electrodes 56 of each row.

### Modified Embodiment

The invention is not limited to the above-described embodiments, but may be modified or improved within a scope of the gist of the invention is achieved.

For example, the control circuit 30 is just one example. As long as the voltage of the common lines Z1 to Z320 is configured as the waveform in the entire screen display mode shown in FIG. 10 and the waveform in the partial screen display mode shown in FIG. 13, the control circuit 30 is not limited to the configurations shown in FIGS. 6 to 8. Similarly, the control circuit 30A is just one example. As long as the voltage of the common lines Z1 to Z320 is configured as the waveform in the entire screen display mode shown in FIG. 10 and the waveform in the partial screen display mode shown in FIG. 24, the control circuit 30 is not limited to the configurations shown in FIGS. 21 to 23.

In the above-described embodiments, the scanning lines Y of 320 rows and the data lines X of 240 columns are provided, but the invention is not limited thereto. For example, the scanning line Y of 480 rows and the data lines X of 640 columns may be provided.

In the above-described embodiments, the transmissive display is carried out, but the invention is not limited thereto. For example, transflective display combining the transmissive display that uses light from the backlight 90 and a reflective display that uses reflected light of outside light may be carried out.

In the above-described embodiments, the liquid crystal operate in the normally black mode, but the invention is not limited thereto. For example, the liquid crystal may operate in a normally white mode.

In the above-described embodiments, as TFTS, TFTs 51 formed of amorphous silicon are provided, but the invention is not limited thereto. For example, the TFT formed low-temperature silicon may be provided.

In the above-described embodiments, the second insulating film 64 is formed on the common electrodes 56 and the pixel electrodes 55 are formed on the second insulating film 64, but the invention is not limited thereto. For example, the second insulating film 64 may be formed on the pixel electrodes 55 and the common electrodes 56 may be formed on the second insulating film 64. That is, in each pixel, one of the rectangular pixel electrode 55 and the belt-shaped common electrode 56 may be positioned on an upper layer and the other thereof may be positioned on a lower layer. In addition, any one thereof may be positioned on the lower layer. However, the slit-shaped opening 55A is provided on the upper layer, that the layer to which the liquid crystal is close.

In the above-described embodiments, the liquid crystal operates in an FFS mode, but the invention is not limited thereto. For example, the liquid crystal may operate in an IPS mode may be provided.

In the above-described embodiments, the common electrodes 56 are provided every horizontal line, but the invention is not limited thereto. For example, the common electrodes 56 may be provided to be partitioned every two horizontal lines or every three horizontal lines. In this case, when the common electrodes 56 (the common lines) are provided to be partitioned every two horizontal lines and the number of the scanning lines is “320”, for example, the number of the common lines may be “160” which is a half the number of the scanning lines. In this case, the control circuit 30 (30A) switches the voltage from any one of the voltage VCOML and VCOMH to the other whenever selecting the scanning lines every two lines. For this reason, since application polarity of each row is carried out in order of the positive polarity→the positive polarity→the negative polarity→the negative polarity→(the positive polarity), the data line driving circuit 20 alternately supplies the positive image signal and the negative image signal on the basis of the application polarity whenever the two scanning lines are selected. In addition, when the plurality of lines are reversed, the supplementary common lines may be provided in every row, only one supplementary common line may be provided, and the supplementary common line may not provided. The modification, improvement, or the like are included as long as the gist of the invention can be embodied.

In the above-described embodiments, the data line driving circuit 20 and the partial circuit 40 are individually provided, but it is not limited thereto. For example, the data line driving circuit 20 and the partial circuit 40 may be incorporated.

In the above-described embodiment, the scanning line driving circuit 10 is configured to have the shift register 11, but it is not limited thereto. For example, a decoder may be provided instead of the shift register 11. When the scanning line driving circuit 10 includes the decoder instead of the shift register 11, the pulse signal of the H level is sequentially output in the manner of the 1st row, 2nd row, 3rd row, . . . , the 320th row. However, the output order is not limited thereto and may be configured arbitrarily. Moreover, the pulse signal may be output only to the predetermined rows.

### Electronic Apparatus

Next, an example of an electronic apparatus to which the liquid crystal device according to the above-described embodiments will be described.

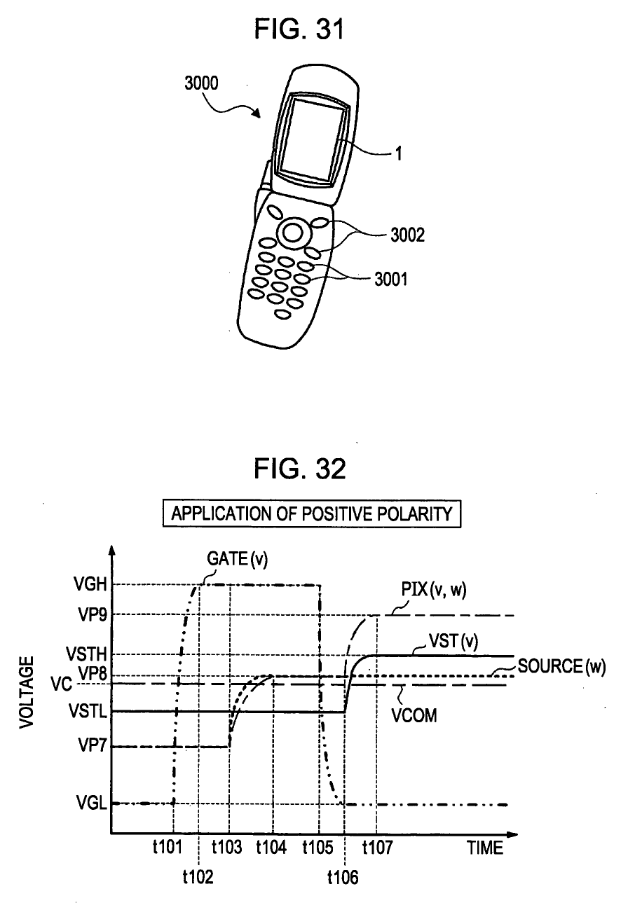

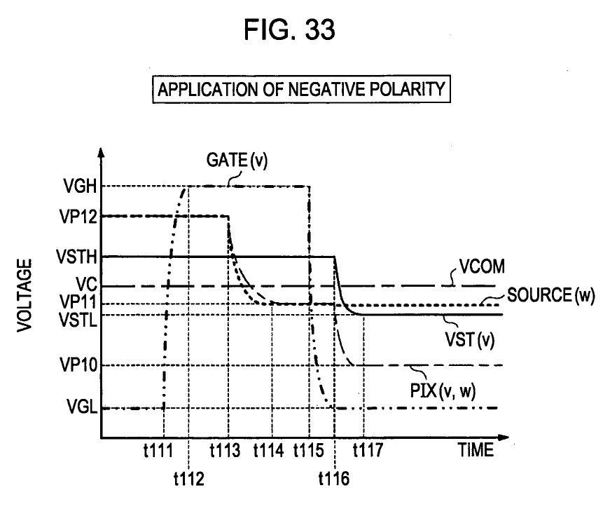

FIG. 31 is a perspective view illustrating a configuration of a cellular phone to which the liquid crystal device 1 is applied. A cellular phone 3000 includes a plurality operation buttons 3001, scroll buttons 3002, and the liquid crystal device 1. An image displayed on the liquid crystal device 1 is scrolled by operating the scroll buttons 3002.

The electronic apparatus to which the liquid crystal device 1 is applied includes a personal computer, an information portable terminal, a digital still camera, a liquid crystal television, a view finder type or monitor direct vision-type video tape recorder, a car navigation apparatus, a pager, an electronic pocket book, a calculator, a word processor, a work station, a television phone, a POS terminal, a touch panel and the like in addition to the cellular phone. As a display portion of the various types of electronic apparatus, the above-described liquid crystal device is applicable.

The entire disclosure of Japanese Patent Application Nos. 2006-264486, filed Sep. 28, 2006 and 2007-200434, Aug. 1, 2007 are expressly incorporated by reference herein.

What is claimed is:

1. A driving circuit of a liquid crystal device having a first substrate, a second substrate disposed opposite the first substrate, and liquid crystal interposed between the first substrate and the second substrate, wherein the first substrate has a plurality of scanning lines, a plurality of data lines, a plurality of common electrodes provided every predetermined number of scanning lines, and pixels that are provided at intersections between the scanning lines and the data lines, that each have a pixel switching element of which one end is connected to the corresponding data line and which is conductive with an application of a selection voltage to the scanning line, and a pixel capacitor of which one end is connected to the corresponding common electrode and the other end is connected to the other end of the pixel switching element, and that exhibit gray scales corresponding to holding voltages of the pixel capacitors and wherein any one can be selected out of an entire screen display mode in which an effective display is performed using all the pixels and a partial screen display mode in which effective display is performed using only the pixels corresponding to the scanning lines associated with a display area and the pixels corresponding to scanning lines associated with a non-display area are not used, the driving circuit comprising;
a scanning line driving circuit for supplying the selection voltage to the plurality of scanning lines in a predetermined order in the entire screen display mode and in the partial screen display mode;
a first control circuit for supplying the plurality of common electrodes with any one of a first voltage, a second voltage higher than the first voltage, and a predetermined voltage, for switching a voltage applied to a common electrode corresponding to one scanning line from any one of the first voltage and the second voltage to the other before the selection voltage is applied to the one scanning line in the entire screen display mode and before the selection voltage is applied to one scanning line associated with the display area in the partial screen display mode, and for holding the voltage applied to common electrodes corresponding to the scanning lines associated with the non-display area in the partial screen display mode at any one of the first voltage, the second voltage, and the predetermined voltage;
a data line driving circuit for supplying a positive image signal having a voltage corresponding to the gray scale of pixels corresponding to the scanning lines to which the selection voltage is applied and being higher than the first voltage when a common electrode corresponding to the scanning line to which the selection voltage is applied is switched to the first voltage and for supplying a negative image signal having the voltage corresponding to the gray scales of pixels and being lower than the second voltage when the common electrode corresponding to the scanning line to which the selection voltage is applied is switched to the second voltage in a case where the selection voltage is applied to one of the plurality of scanning lines in the entire screen display mode and in a case where the selection voltage is applied to any one of the scanning lines associated with the display area in the partial screen display mode; and
a second control circuit for supplying the data lines with the voltage applied to the common electrode corresponding to the scanning line to which the selection voltage is applied when the selection voltage is applied to one of the scanning lines associated with the non-display area in the partial screen display mode.

2. The driving circuit according to claim 1, wherein the data line driving circuit alternately switches between the positive image signal and the negative image signal whenever the predetermined number of scanning lines is selected.

3. The driving circuit according to claim 1, wherein the first control circuit has a latch circuit and a selection circuit,
wherein the latch circuit has unit latch circuits provided for the plurality of common electrodes,
wherein each unit latch circuit latches a polarity signal for instructing use of a positive polarity or negative image signal to the data line driving circuit when the selection voltage is applied to one of two lines adjacent to the scanning line corresponding to the corresponding common electrode,
wherein the selection circuit has unit selection circuits provided for the plurality of common electrodes,
wherein all the unit selection circuits in the entire screen display mode and the unit selection circuit corresponding to the common electrode corresponding to the scanning lines associated with the display area in the partial screen display mode apply one of the first voltage and the second voltage to the corresponding common electrode on the basis of the polarity signal latched by the latch circuit, and
wherein the unit selection circuits corresponding to the common electrode corresponding to the scanning line associated with the non-display area in the partial screen display mode apply one of the first voltage, the second voltage, and the predetermined voltage to the corresponding common electrode.

4. The driving circuit according to claim 1, wherein the first control circuit has a latch circuit and a selection circuit,
wherein the latch circuit has unit latch circuits provided for the plurality of common electrodes,
wherein each unit latch circuit latches a polarity signal for instructing use of a positive polarity or negative image signal to the data line driving circuit when the selection voltage is applied to the more previous scanning line by one line than the scanning line corresponding to the corresponding common electrode,
wherein the selection circuit has unit selection circuits provided for the plurality of common electrodes, wherein all the unit selection circuits in the entire screen display mode and the unit selection circuits corresponding to the common electrodes corresponding to the scanning lines associated with the display area in the partial screen display mode apply one of the first voltage and the second voltage to the corresponding common electrodes on the basis of the polarity signal latched by the latch circuit, and
wherein the unit selection circuits corresponding to the common electrodes corresponding to the scanning line associated with the non-display area in the partial screen display mode apply one of the first voltage, the second voltage, and the predetermined voltage to the corresponding common electrode.

5. The driving circuit according to claim 1, wherein the first control circuit has a latch circuit and a selection circuit,
wherein the latch circuit has unit latch circuits provided for the plurality of common electrodes,
wherein each unit latch circuit latches a polarity signal for instructing use of a positive polarity negative image signal to the data line driving circuit when the selection voltage is applied to the more previous scanning line by one line than the scanning line corresponding to the common electrode,
wherein the selection circuit has a first unit selection circuit provided corresponding to the common electrode corresponding to the scanning line associated with a predetermined display area and a second unit selection circuit provided on the basis of the common electrode corresponding to the scanning line associated with a predetermined non-display area,
wherein the first unit selection circuit applies one of the first voltage and the second voltage to the corresponding common electrode on the basis of the polarity signal latched by the latch circuit, and
wherein the second unit selection circuit applies one of the first voltage and the second voltage to the corresponding common electrode on the basis of the polarity signal latched by the latch circuit in the entire screen display mode and applies one of the first voltage, the second voltage, and the predetermined voltage to the corresponding common electrode in the partial screen display mode.

6. A method of driving a liquid crystal device having a first substrate, a second substrate disposed opposite the first substrate, and liquid crystal interposed between the first substrate and the second substrate, wherein the first substrate has a plurality of scanning lines, a plurality of data lines, a plurality of common electrodes provided every predetermined number of scanning lines, and pixels that are provided at intersections between the scanning lines and the data lines, that each have a pixel switching element of which one end is connected to the corresponding data line and which is conductive with an application of a selection voltage to the scanning line, and a pixel capacitor of which one end is connected to the corresponding common electrode and the other end is connected to the other end of the pixel switching element, and that exhibit gray scales corresponding to holding voltages of the pixel capacitors, wherein any one can be selected out of an entire screen display mode in which an effective display is performed using all the pixels and a partial screen display mode in which the effective display is performed using only the pixels corresponding to scanning lines associated with a display area and the pixels corresponding to the scanning lines associated with a non-display area are not used, and wherein the selection voltage is supplied to the plurality of scanning lines in a predetermined order in the entire screen display mode and in the partial screen display mode, the method comprising;
in the entire screen display mode,
switching a voltage applied to the common electrode corresponding to the one scanning line from one of a first voltage and a second voltage higher than the first voltage to the other before applying the selection voltage to the one scanning line,
supplying a positive image signal having a voltage corresponding to gray scales of pixels corresponding to the scanning lines to which the selection voltage is applied and being higher than the first voltage to the data line when the common electrode corresponding to the corresponding scanning line to which the selection voltage is applied is switched to the first voltage in a case where the selection voltage is applied to the one scanning line, and
supplying a negative image signal having the voltage corresponding to the gray scales of pixels and being lower than the second voltage to the data line when the common electrode corresponding to the corresponding scanning line to which the selection voltage is applied is switched to the second voltage;
in the display area in the partial screen display mode,
switching the voltage applied to the common electrode corresponding to the one scanning line from one of the first voltage and the second voltage to the other before applying the selection voltage to the one scanning line associated with the display area,
supplying the positive image signal having the voltage corresponding to the gray scales of pixels corresponding to the scanning lines to which the selection voltage is applied and being higher than the first voltage to the data line when the common electrode corresponding to the corresponding scanning line to which the selection voltage is applied is switched to the first voltage in a case where the selection voltage is applied to the one scanning line, and
supplying the negative image signal having the voltage corresponding to the gray scales of pixels and being lower than the second voltage when the common electrode corresponding to the corresponding scanning line to which the selection voltage is applied is switched to the second voltage; and
in the non-display area in the partial screen display mode,
holding the voltage applied to the common electrode corresponding to the one scanning line associated with the non-display mode in one of the first voltage, the second voltage, and a predetermined voltage, and
supplying the voltage applied to the common electrode corresponding to the one scanning line when the selection voltage is applied to the one scanning line.

7. A liquid crystal device having a first substrate, a second substrate disposed opposite the first substrate, and liquid crystal interposed between the first substrate and the second substrate, wherein the first substrate has a plurality of scanning lines, a plurality of data lines, a plurality of common electrodes provided every predetermined number of scanning lines, and pixels that are provided at intersections between the scanning lines and the data lines, that each have a pixel switching element of which one end is connected to the corresponding data line and which is conductive with an application of a selection voltage to the scanning line, and a pixel capacitor of which one end is connected to the corresponding common electrode and the other end is connected to the other end of the pixel switching element, and that exhibit gray scales corresponding to holding voltages of the pixel capacitors and wherein any one can be selected out of an entire screen display mode in which an effective display is performed using all the pixels and a partial screen display mode in which the effective display is performed using only the pixels corresponding to the scanning lines associated with a display area and the pixels corresponding to the scanning lines associated with a non-display area are not used, the liquid crystal device comprising;
a scanning line driving circuit for supplying the selection voltage to the plurality of scanning lines in a predetermined order in the entire screen display mode and in the partial screen display mode;
a first control circuit for supplying the plurality of common electrodes with any one of a first voltage, a second voltage higher than the first voltage, and a predetermined voltage, for switching a voltage applied to a common electrode corresponding to one scanning line from any one of the first voltage and the second voltage to the other before the selection voltage is applied to the one scanning line in the entire screen display mode and before the selection voltage is applied to one scanning line associated with the display area in the partial screen display mode, and for holding the voltage applied to common electrode corresponding to the scanning line associated with the non-display area in the partial screen display mode at any one of the first voltage, the second voltage, and the predetermined voltage;
a data line driving circuit for supplying a positive image signal having a voltage corresponding to the gray scales of pixels corresponding to the scanning lines to which the selection voltage is applied and being higher than the first voltage when the common electrode corresponding to the scanning line to which the selection voltage is applied is switched to the first voltage and for supplying a negative image signal having a voltage corresponding to the gray scales of pixels and being lower than the second voltage when the common electrode corresponding to the scanning line to which the selection voltage is applied is switched to the second voltage in a case where the selection voltage is applied to one of the plurality of scanning lines in the entire screen display mode and in a case where the selection voltage is applied to any one of the scanning lines associated with the display area in the partial screen display mode; and
a second control circuit for supplying the data lines with the voltage applied to the common electrode corresponding to the scanning line to which the selection voltage is applied when the selection voltage is applied to one of the scanning lines associated with the non-display area in the partial screen display mode.

8. The liquid crystal device according to claim 7,
wherein the plurality of common electrodes correspond to the plurality of scanning lines line by line and are opposed to a line of the pixel electrodes along an extending direction of the scanning lines line by line, and
wherein supplementary common lines of the common electrodes are disposed along the extending direction of the scanning lines and the common electrodes and a set of a common electrode and a supplementary common line are connected to each other through contact wirings provided at a predetermined interval.

9. An electronic apparatus comprising the liquid crystal device according to claim 7.
